(19) United States
(12) Patent Application Publication
(10) Pub. No.: US 2026/0289980 A1
(43) Pub. Date: Sep. 24, 2026

(54) Configuring Machine Learning Pipelines Based on Region Comprehension Indexes

(71) Applicant: Oracle International Corporation, Redwood Shores, CA (US)

(72) Inventors: Amit Agarwal, Seattle, WA (US); Hitesh Laxmichand Patel, Jersey City, NJ (US); Hansa Meghwani, Bengaluru (IN)

(73) Assignee: Oracle International Corporation, Redwood Shores, CA (US)

(21) Appl. No.: 19/325,063

(22) Filed: Sep. 10, 2025

Related U.S. Application Data
(60) Provisional application No. 63/774,375, filed on Mar. 19, 2025.

(51) Int. Cl. G06V 10/776; G06V 10/778

(52) U.S. Cl. CPC G06V 10/776; G06V 10/778

(57) ABSTRACT

Techniques for configuring a machine learning (ML) pipeline are disclosed. A system generates a region comprehension index (RCI) value that quantifies, for a visual dataset supplied to a computer vision model (CVM), a bias toward global or local reasoning. The system determines a first performance metric at least by applying the CVM to a whole image included in the visual dataset and a second performance metric at least by applying the CVM to patches of the whole image. The system determines the RCI value as a function of at least the first performance metric and the second performance metric. If the RCI value satisfies a criterion for deploying the CVM to an ML pipeline, the system selectively deploys the CVM to the ML pipeline.

### BENEFIT CLAIMS; RELATED APPLICATIONS; INCORPORATION BY REFERENCE

This application claims the benefit of U.S. Provisional Patent Application 63/774,375, filed Mar. 19, 2025, which is hereby incorporated by reference.

The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to machine learning (ML) models. In particular, the present disclosure relates to ML models that process visual data.

### BACKGROUND

Different types of ML models are deployed in various settings to perform different tasks. Some ML models perform tasks that process visual data (e.g., photographs, video feeds, human-generated images, etc.). Examples of such ML models include, but are not limited to, visual language models (VLMs) and multimodal language models (MLLMs). For ease of discussion, ML models that process visual data are referred to herein as computer vision models (CVMs), even if they also process other types of data. Visual data is also referred to herein as image data.

Performance of CVMs is often inconsistent. For example, many CVMs perform better on some benchmarks and not as well on other benchmarks. Furthermore, one CVM may perform better than another CVM for one benchmark but not as well as the other model for another benchmark. Also, many CVMs perform better for certain types of tasks as opposed to other types of tasks. Unknown biases that exist in CVMs, training data, and benchmarking result in inefficient and suboptimal model training, selection, and performance for ML pipelines and related systems.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the Figures of the accompanying drawings. It should be noted that references to “an” or “one” embodiment in this disclosure are not necessarily to the same embodiment, and they mean at least one. In the drawings:

FIG. 1 illustrates an ML pipeline configuration system in accordance with one or more embodiments;

FIG. 2 illustrates an example set of operations for configuring an ML pipeline in accordance with one or more embodiments;

FIGS. 3A-F illustrate examples of ML pipeline configuration in accordance with one or more embodiments;

FIG. 4 illustrates an ML engine in accordance with one or more embodiments;

FIG. 5 illustrates the operation of an ML engine in accordance with one or more embodiments; and

FIG. 6 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. PRACTICAL APPLICATIONS, ADVANTAGES, AND IMPROVEMENTS
3. ML PIPELINE CONFIGURATION SYSTEM
4. OPERATIONS FOR ML PIPELINE CONFIGURATION
5. EXAMPLE PERFORMANCE METRICS FOR ML PIPELINE CONFIGURATION SYSTEM
   5.1. Performance Metrics
   5.2. Examples of Region Comprehension Indexes (RCIs)
   5.3. Global Reasoning Deployment
   5.4 Local Reasoning Deployment
   5.5. Synthetic Dataset Construction
6. ML ARCHITECTURE
7. ML OPERATIONS
8. GENERATIVE ARTIFICIAL INTELLIGENCE MODELS
9. COMPUTER NETWORKS AND CLOUD NETWORKS
10. MICROSERVICE APPLICATIONS
11. HARDWARE OVERVIEW
12. MISCELLANEOUS; EXTENSIONS

### 1. General Overview

A CVM may have a bias toward global or localized image data. A CVM with a bias toward global image data performs better when given a whole image. A CVM with a bias toward localized image data performs better when given patches of an image. Some CVMs are heavily biased toward global image data and other CVMs are heavily biased toward localized image data. Some CVMs are biased toward a particular task type. Still other CVMs fall somewhere in between, without being heavily biased toward global, localized, and/or task-type-related image data.

A dataset used to train a CVM may have a global or localized reasoning requirement. A dataset with a global reasoning requirement yields better performance when used to train a CVM with a bias toward global image data. A CVM performs better in a deployment setting with a global reasoning requirement when trained on a dataset with a global reasoning requirement.

A dataset with a localized reasoning requirement yields better performance when used to train a CVM with a bias toward localized image data. A CVM yields better performance in a deployment setting with a local reasoning requirement when trained on a dataset with a local reasoning requirement.

Some datasets have strong global reasoning requirements and other datasets have strong localized reasoning requirements. Still other datasets fall somewhere in between, without having strong global or localized reasoning requirements. Some deployment settings have strong global reasoning requirements and other deployment settings have strong localized reasoning requirements. Still other deployment settings fall somewhere in between, without having strong global or localized reasoning requirements. Some datasets have strong localized reasoning requirements and/or task-related reasoning requirements. Other datasets have strong biases against localized reasoning requirements and/or task-related reasoning requirements. Some deployment settings have strong localized and/or task-related reasoning requirements. Other deployment settings have strong biases against localized and/or task-related reasoning requirements.

One or more embodiments calculate one or more values of region comprehension indexes (RCIs) to quantify (a) CVMs' relative biases toward global or localized image data and/or (b) datasets' relative global or localized reasoning requirements. Here, the term “region” refers to the fact that a CVM or dataset may favor processing a particular region of an image. In addition to local bias (favoring processing of smaller regions) and global biases (favoring processing of the whole image), some examples of regional biases include right-bias, top-bias, corner-bias, central-bias, perimeter-bias, etc.

One or more embodiments use RCI values to configure an ML pipeline by performing one or more of the following:
1. Deploying or publishing a CVM to the ML pipeline contingent on the CVM's RCI value satisfying a threshold criterion.
2. Using RCI values for multiple CVMs to determine which CVM to deploy for a particular type of data ingested by the ML pipeline.
3. Based on RCI values for different datasets applied to the same CVM(s), selecting a particular dataset to train a target CVM in the ML pipeline. Different stages of training may use different datasets and/or mixtures of datasets.
4. Based on one or more RCI values for different datasets applied to CVMs for a type of task, selecting a CVM for the type of task.
5. Generating patch contribution heatmaps that visually represent the relative importance of patch locations. The importance of a patch location may be based on average performance and/or how often the patch location is the maximum performing patch location. Heatmaps reveal regional biases and may be used to analyze visual data and generate synthetic datasets having certain properties.
6. Applying noise and/or masking to datasets to generate “adversarial” datasets that are conditioned to be more globally or locally biased and/or applying noise and/or masking to generate “adversarial” datasets that are conditioned to be more biased or less biased toward a particular region. For example, generating an adversarial dataset may mask patches with critical information and/or perform other selective manipulation of image data in the dataset to make some visual language tasks more difficult. Training a CVM on an adversarial dataset may enhance the CVM's robustness.

One or more embodiments described in this Specification and/or recited in the claims may not be included in this General Overview section.

### 2. Practical Applications, Advantages, and Improvements

One or more embodiments use RCIs to improve the performance of an ML pipeline in one or more of the following ways.

One or more embodiments automatically evaluate and select one or more CVMs for the ML pipeline. Specifically, one or more embodiments select, from multiple candidate CVMs, a CVM that performs better for the type of data ingested by the ML pipeline.

One or more embodiments automatically evaluate and select one or more CVMs for a task type or deployment setting, also referred to as a deployment environment (e.g., a server, data center, virtual machine, container, etc.). In particular, one or more embodiments select, from multiple CVMs, a CVM that performs better for the type of task or deployment setting. For example, a deployment setting or task type may require a CVM to perform a particular task type, such as captioning, visual reasoning, optical character recognition, or another type of visual language task. One or more embodiments select a CVM, from the multiple CVMs, that performs best for that task type.

One or more embodiments automatically evaluate and select, from multiple candidate datasets, training data that yields better performance for a particular purpose. Particular purposes may include, for example, evaluating a CVM's suitability for a given task type, evaluating a CVM's suitability for a given deployment setting, and/or training a CVM. For example, based on an RCI value for a data item, one or more embodiments may include the data item in a dataset used to train a CVM to perform a given task that benefits more from processing global or local image data.

One or more embodiments improve the composition of training data for training a particular CVM, compared with approaches that do not evaluate training data for regional biases. For example, one or more embodiments may generate “buckets” of datasets with global reasoning requirements and/or “buckets” of datasets with local reasoning requirements. Different stages of CVM training may use different data compositions and/or mixtures of datasets to improve model performance. In an embodiment, an RCI value quantifies a regional bias, such as a bias toward local reasoning or global reasoning, for visual data. One or more embodiments use buckets of training data that satisfy an RCI threshold criterion (e.g., indicating a bias for a particular task type) to train a CVM for a deployment involving that task type.

One or more embodiments generate different categories of benchmark datasets for evaluation and benchmarking. One or more embodiments deploy a CVM contingent on the CVM's RCI value satisfying one or more performance criteria (e.g., thresholds) that are based on different datasets with different hardness levels. Deploying a CVM contingent on meeting such performance criteria improves the CVM's quality and performance.

One or more embodiments generate synthetic datasets to train a CVM for robustness. One or more embodiments may apply one or more filters, apply noise, mask patches with critical information, mask patches without critical information, and/or apply random distortions to existing datasets. A filter is used to selectively alter an image by changing the appearance of at least a portion of the image. For example, various filters are suitable for brightening an image, darkening an image, changing a hue of an image, adding an effect to an image, and so forth. Random distortions may include masking, adding noise, rotation, shuffling, and/or other distortions. Some embodiments use masking to further increase the hardness or robustness of a training data bucket and/or to compose a training data bucket suited for training a model to perform a particular type of task. For example, some embodiments selectively mask patches to create a synthetic dataset that has a regional bias. Different masking techniques can be used to generate a bucket of data with a local reasoning bias, global reasoning bias, central reasoning bias, perimeter reasoning bias, left bias, right bias, top bias, bottom bias, or the like. Such buckets of data are well suited for training or fine-tuning a CVM to perform a corresponding task type.

In general, one or more embodiments improve ML pipeline configuration and performance by improving both (1) model selection, and (2) training data selection. Improved model and/or training data selection reduces deployments of inefficient models and/or datasets. Inefficient models and/or datasets consume more computing resources than efficient models and/or datasets. Based on RCIs, one or more embodiments adapt the ML pipeline to the different needs of different settings, allowing the ML pipeline to support a variety of applications without needing to hard-code specific workflows for the applications. Avoiding the need to hard-code specific workflows improves the functioning of the system by supporting applications that were not anticipated when the pipeline was developed.

### 3. ML Pipeline Configuration System

An ML pipeline configuration system selects and/or deploys one or more CVMs to one or more deployment settings for various tasks. One or more embodiments train and/or deploy a CVM to a deployment setting based on a task type, a regional reasoning requirement, and/or a metric.

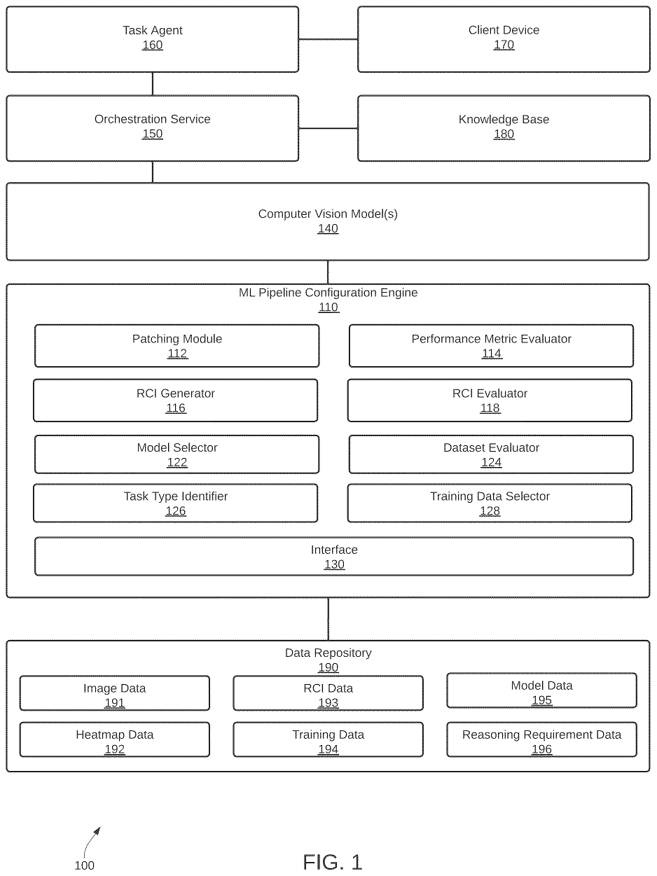

FIG. 1 illustrates an ML pipeline configuration system 100. In the example, the ML pipeline configuration system 100 includes an ML pipeline configuration engine 110, one or more CVMs 140, an orchestration service 150, a task agent 160, a client device 170, a knowledge base 180, and a data repository 190.

In FIG. 1, the ML pipeline configuration engine 110 includes a patching module 112, a performance metric evaluator 114, an RCI generator 116, an RCI evaluator 118, a model selector 122, a dataset evaluator 124, a task type identifier 126, a training data selector 128, and an interface 130.

The patching module 112 is configured to divide image data into smaller, structured sections, referred to as patches. One or more embodiments divide an image into a grid of rectangular patches that partitions the image into non-overlapping rows and columns. In some cases, the number of rows equals the number of columns, and the patches are equally sized. However, one or more embodiments define patches that are other shapes or configurations, including equal patch size(s), unequal patch size(s), and/or equal or unequal numbers of rows and columns. The patching module 112 is configured to segment or crop images into the patches. The patching module 112 may be configured to maintain a patch index that stores metadata about the locations and/or sources of patches.

The performance metric evaluator 114 is configured to assess the performance of one or more CVMs when performing tasks using a particular set of visual data (e.g., images). The performance metric evaluator 114 may include one or more evaluation tools, statistical analysis algorithms, and/or metric computation functions configured to calculate and report various quantitative measures of model output performance, accuracy, or quality. For example, the performance metric evaluator 114 may assess results from several models performing a variety of image language tasks. The performance metric evaluator 114 evaluates a CVM's whole image performance and patch performance for a task. Various performance measures include, but are not limited to, accuracy, precision, recall, F1 score, outputs of loss functions, and/or combinations thereof.

In various embodiments, the performance metric evaluator 114 assesses one or more benchmarks. Example benchmarks include multimodal bench (MMBench), massive multi-discipline multimodal understanding (MMMU), and document visual question answering (DocVQA). A benchmark may include one or more benchmark tasks and/or one or more sets of benchmark data items that are suitable for large-scale and/or fine-grained evaluation of a CVM. One or more embodiments use a CVM to process patches (at one or more granularities) and whole images to generate one or more task-specific outputs, such as an answer for a visual question, a caption for an image description task, and/or a spatial reasoning task. One or more embodiments compare the answers and/or captions with a ground truth to determine how well the benchmark performs (e.g., accuracy or another metric). The performance metric evaluator 114 assesses one or more of the following: an average patch performance for one or more patches, a maximum patch performance for the patches, a performance for a selection of patch locations, a whole image performance, etc.

The RCI generator 116 is configured to compute RCI values based on performance metrics for visual data (e.g., images or video frames). For example, the RCI generator 116 may compute a metric proportional to a quotient of a patch performance (e.g., a maximum patch performance or an average patch performance) divided by a whole image performance. Specifically, one or more embodiments compute a proportionality constant k, which may be calculated as

$$k = \frac{{P}_{patch}}{{P}_{whole}}$$

where P_{patch} is the CVM performance using patches to perform a task and P_{whole} is the CVM performance using the whole image. In one or more embodiments, P_{patch} quantifies maximum patch performance for a set of patches and/or an average of individual patch performances for a set of patches. To compute an RCI, one or more embodiments also apply one or more normalizing constants and/or additive or subtractive constants to k. For example, one or more embodiments may compute an RCI as

$$RCI = n \pm m \times k$$

where n is an additive or subtractive constant and m is a normalizing constant. Alternatively, or additionally, computing an RCI value may include one or more other constant and/or variable values.

The RCI generator 116 accesses one or more CVMs and one or more datasets. The RCI generator 116 generates an RCI for a dataset by instructing a visual language model to perform a visual reasoning task using a whole image of the dataset and using patches of the whole image of the dataset. In embodiments, a dataset includes many images. Also, in some embodiments, more than one visual language model performs the visual reasoning task on the dataset. The RCI generator 116 aggregates scores for the visual language models to compute a combined or aggregated RCI score for the dataset. This aggregated RCI score measures if patch performance for a dataset is poor relative to whole image performance for the dataset.

The RCI evaluator 118 is configured to categorize a model and/or a dataset based on one or more RCI values. For example, the RCI evaluator 118 may receive one or more RCI values associated with a dataset and, based on the one or more RCI values, determine if the dataset is suitable for training a particular model for a particular task. The RCI evaluator 118 evaluates an RCI value against one or more threshold criteria to determine a category or type for a model or a dataset. For example, a dataset that consistently has low RCIs (e.g., values near or below zero) is biased towards local information. Conversely, a dataset that consistently has high RCI values (e.g., scores near one) is biased towards global information. In general, the RCI evaluator 118 is configured to determine if one or more RCI values indicate(s) a regional bias such as a global or local bias.

In some embodiments, the RCI evaluator 118 assesses a set of RCI values that are associated with a particular model. In this example, relatively lower RCI values indicate that the model is biased towards tasks using local information, or the model performs relatively better for tasks performed on datasets that have a local information bias. Conversely, high RCI values indicate that the model is biased towards (or performs better for) tasks using global information.

In some embodiments, the RCI evaluator 118 uses threshold criteria to categorize reasoning dependencies. For example, the RCI evaluator 118 may define separate categories for RCIs under −0.2, between −0.2 and 0.0, between 0.0 and 0.2, between 0.2 and 0.8, between 0.8 and 1.0, and above 1.0. These categories and ranges are examples only; other embodiments may define different categories and/or ranges. Values that fall exactly on the cusp of two categories may fall into one or the other category depending on how the thresholds are defined. The RCI evaluator 118 determines to which category(ies) an RCI value belongs.

The model selector 122 is configured to select one or more CVMs 140 for benchmarking, testing, training, deployment, or the like. The model selector 122 is configured to compare RCI values and/or performance metrics for a CVM 140 to one or more predefined thresholds, to determine whether or not to select the CVM 140 for training and/or for a particular deployment setting. In various embodiments, the model selector 122 selects different CVMs 140 based on different thresholds associated with a target deployment. The model selector 122 selects models for training, benchmarking, and/or deployment based on reasoning requirements for a deployment setting (or other use case), an RCI value, and/or another performance metric.

The dataset evaluator 124 is configured to identify characteristics of datasets. In an embodiment, the system 100 selectively uses datasets for training or testing within the ML pipeline based on the identified characteristics. In embodiments, the dataset evaluator 124 determines characteristics of a dataset that include an RCI value, an average global performance, an average patch performance (at one or more granularities), a regional bias, and/or another characteristic. In embodiments, the dataset evaluator 124 determines whether or not to use the dataset for training, benchmarking, masking, and/or distortion.

In some embodiments, the dataset evaluator 124 determines if a dataset has a local bias or global bias based on one or more RCI values associated with the dataset. For example, one or more embodiments may average one or more RCI values associated with the dataset to obtain an average RCI value. The dataset evaluator 124 determines that a dataset with an averaged RCI value has a local bias if the averaged RCI value is below a threshold for benchmarking tasks using the CVM(s) 140 and the dataset. Conversely, the dataset evaluator 124 determines that a dataset with an averaged RCI value has a global bias if the averaged RCI value is above a threshold benchmarking tasks using the CVM(s) 140 and the dataset.

In some embodiments, the dataset evaluator 124 determines a characteristic of a dataset using a data structure corresponding to a heatmap and/or based on an RCI value that was generated using a masked version of the dataset. Some examples of masking to generate a masked version of a dataset are described in further detail herein. By way of example, the dataset evaluator 124 may determine if a dataset has a central bias or a perimeter bias by evaluating data that indicates the locations and frequencies of maximum performing patches for tasks performed using data items in the dataset. The dataset evaluator 124 determines a number of maximum performing patch results for patch locations near a center of an image and a number of maximum performing patch results that are near a perimeter of the image to determine if the dataset has a central bias or a perimeter bias. Specifically, a greater number of maximum performing patch locations in a particular region (e.g., near a center or near a perimeter of the image) indicates a bias toward that region.

The task type identifier 126 is configured to determine a type associated with a task, model, dataset, or deployment setting. For example, the task type identifier 126 may evaluate a particular use case or deployment setting to determine one or more task types performed during workflows associated with the deployment setting. The task type identifier 126 analyzes the tasks to determine if the tasks are local reasoning tasks or global reasoning tasks. In some embodiments, the task type identifier 126 identifies a reasoning requirement associated with a task or set of tasks. In embodiments, task type identifier 126 identifies a hardness or robustness requirement associated with a deployment setting. For example, the task type identifier 126 may identify the task types of a deployment setting as being global-reasoning biased. In another example, the task type identifier 126 identifies a task type as requiring that a performance criterion be satisfied by an RCI value for a model performing tasks of that type on a particular dataset.

The training data selector 128 is configured to select training data from one or more datasets for use in model training and/or fine tuning. The training data selector 128 applies one or more selection criteria based on an RCI value, a combined RCI value, a patch performance metric, a whole image performance metric, and/or another criterion, to construct a new dataset that is suitable for training and/or benchmarking a target CVM. For example, the training data selector 128 may generate a set of training data by aggregating data items that meet a threshold RCI criterion.

In one or more embodiments, interface 130 refers to hardware and/or software configured to facilitate communications between a user and one or more other components of system 100. Interface 130 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

n an embodiment, different components of interface 130 are specified in different languages. The behavior of user interface elements is specified in a dynamic programming language, such as JavaScript. The content of user interface elements is specified in a markup language, such as hypertext markup language (HTML) or XML User Interface Language (XUL). The layout of user interface elements is specified in a style sheet language, such as Cascading Style Sheets (CSS). Alternatively, interface 130 is specified in one or more other languages, such as Java, C, or C++.

In an embodiment, one or more CVMs 140 integrate multiple modalities, such as text, images, and/or video. In embodiments, a CVM 140 is a public or private model. Examples of public multimodal CVMs include contrastive language-image pretraining (CLIP) models, Flamingo, and generative pre-trained transformer models such as GPT-4V. CVMs 140 are accessible to backend components of the orchestration service 150 and are structured to process input retrieved from a client device 170 or a knowledge base 180. A CVM 140 may be trained to perform tasks, such as image captioning or visual question answering.

The orchestration service 150 is configured to orchestrate or coordinate operation of other components of the ML pipeline configuration engine 110 by performing tasks such as routing queries, invoking the appropriate CVM, managing feedback loops based on subsequent input for model improvement, etc. For example, the orchestration service 150 may communicate with a task agent 160, one or more CVM(s) 140, and/or the knowledge base 180 to perform response generation based on an input from client device 170. In some embodiments, the orchestration service 150 is configured to evaluate which CVM 140 to use based on a task type.

The task agent 160 is configured to generate one or more tasks based on inputs from the client device 170. The task agent 160 uses the orchestration service 150 to select and/or utilize one or more CVMs 140 to perform the task(s). The task agent 160 may be configured to perform various task-related functions such as generating tasks, retrieving information from the knowledge base 180 and/or interfacing with a retrieval system, formulating a final response, etc. In various embodiments, the task agent 160 interacts with the client device 170 to receive image uploads. Additionally or alternatively, the task agent 160 may issue commands to generate image captions and/or perform other visual analysis tasks on uploaded images.

The client device 170 is a user-facing hardware component used to interface with the task agent 160. Some examples of client devices 170 include smartphones, tablets, desktop computers, and other devices that support user input and output. The client device 170 facilitates the transmission of text and/or multimodal inputs, such as images and text, from a user's computing environment to the orchestration service 150. The client device 170 includes components for wireless or wired communication, input capture (e.g., touchscreens, cameras, microphones), display output, etc. In some cases, the client device 170 is the source of image uploads, which the multimodal CVM(s) 140 processes via the orchestration service 150.

The knowledge base 180 is a structured data repository that includes information such as curated datasets, vector databases, image stores, document repositories, domain-specific reference material, annotated images, question-answer pairs, and/or other structured content. In an embodiment, the knowledge base 180 supports retrieval-augmented generation (RAG). The knowledge base 180 is accessible to both the orchestration service 150 and the CVM(s) 140 to support context-aware processing, image-based inference, or content augmentation during task execution by the task agent 160.

The data repository 190 stores data accessed or generated by the ML pipeline configuration system 100. Generally, the data repository 190 stores data loaded onto the ML pipeline configuration engine 110 and/or another component of the system 100. As shown, the data repository 190 includes image data 191, heatmap data 192, RCI data 193, training data 194, model data 195, and reasoning requirement data 196.

Image data 191 refers to image/visual data such as photographs, videos, human-generated images, etc. For example, image data 191 may include portable network graphics (PNG) data, graphics interchange format (GIF) data, bitmap (BMP) data, audio video interleave (AVI) data, moving picture experts group (MPEG) data, etc. In some cases, image data 191 may include still images corresponding to frames extracted from video data.

Heatmap data 192 includes a record of relative performance for different patch locations of a visual dataset at one or more granularities. Heatmap data 192 indicates a relative importance of a patch location, such as by identifying the average performance for a corresponding patch location and/or by identifying the number of times the patch location was a best-performing or highest-performing patch location. Specifically, heatmap data 192 may include data that indicates the number of times a particular patch location has been a highest-performing patch location for a model performing a task on patches of a particular image. Heatmap data 192 includes aggregated data for a visual dataset that indicates the number of times or frequency of a particular patch location being a highest-performing patch location when one or more models perform one or more tasks on patches of images in the visual dataset.

The RCI data 193 includes RCI values and may include other information related to RCI values. For example, RCI data 193 may include an RCI value calculated for a model using a visual dataset. RCI data 193 may include other RCI values for the model using other visual datasets. RCI data 193 may include other RCI values for the visual dataset using other models. RCI data 193 may include an index or mapping that maps the stored RCI values to the models and visual datasets.

Training data 194 includes visual data used to train and/or benchmark CVMs. Training data 194 may include public and/or private corpuses of training or benchmarking data. Training data 194 may also include synthetic data generated by the ML pipeline configuration engine 110.

The model data 195 includes outputs, prompts, metadata, parameters, hyperparameters, and/or other data related to CVMs 140. The model data 195 includes various metrics for models that are based on the models' performances and/or RCI values.

Reasoning requirement data 196 refers to data related to the different regional reasoning requirements for training data, benchmarking data, visual language tasks, and deployment settings. In various embodiments, reasoning requirement data includes global reasoning requirement data, local reasoning requirement data, and/or other regional reasoning requirement data.

In one or more embodiments, a data repository 190 is any type of storage unit and/or device (e.g., a file system, database, collection of tables, or any other storage mechanism) for storing data. Furthermore, a data repository 190 may include multiple different storage units and/or devices. The multiple different storage units and/or devices may or may not be of the same type or located at the same physical site. Furthermore, a data repository 190 may be implemented or executed on the same computing system as other components of the ML pipeline configuration system 100. Additionally, or alternatively, a data repository 190 may be implemented or executed on a computing system separate from other components of the ML pipeline configuration system 100. The data repository 190 may be communicatively coupled to one or more other components of the ML pipeline configuration system 100 via a direct connection or via a network.

Information describing the image data 191, heatmap data 192, RCI data 193, training data 194, model data 195, and/or reasoning requirement data 196 may be implemented across any of components within the system 100. However, this information is illustrated within the data repository 190 for purposes of clarity and explanation.

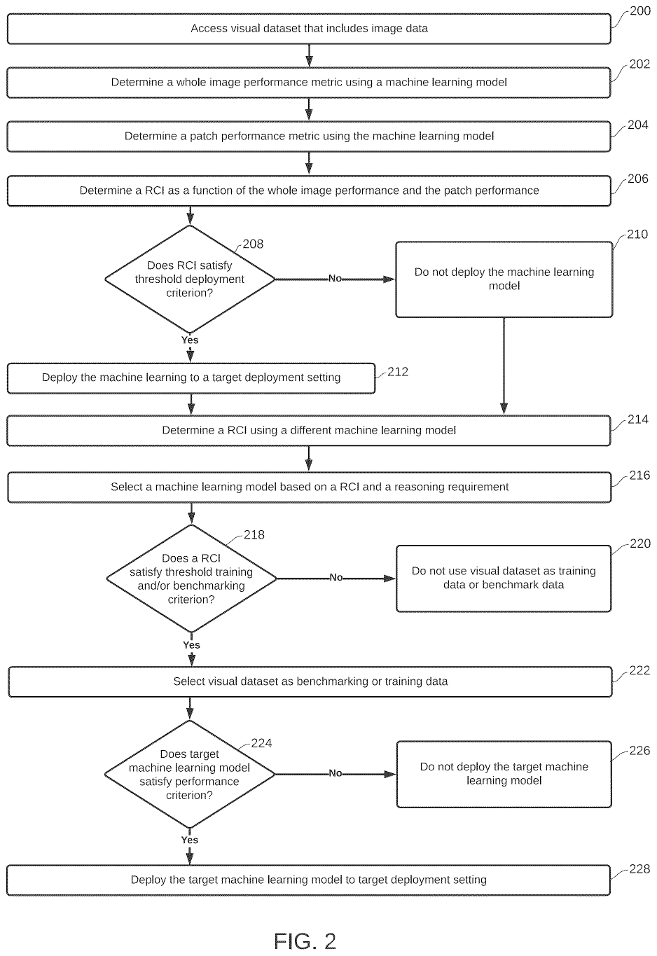

In one or more embodiments, the ML pipeline configuration engine 110 refers to hardware and/or software configured to perform operations described herein for configuring an ML pipeline. Examples of operations for ML pipeline configuration engine 110 and/or other components of the ML pipeline configuration system 100 are described below with reference to FIG. 2.

In an embodiment, components of the system 100 are implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

### 4. Operations for Configuring an ML Pipeline

FIG. 2 illustrates an example set of operations for configuring an ML pipeline in accordance with one or more embodiments. One or more operations illustrated in FIG. 2 may be modified, rearranged, or omitted. Accordingly, the particular sequence of operations illustrated in FIG. 2 should not be construed as limiting the scope of one or more embodiments.

For ease of discussion, operations are described below as being performed by components of the system of FIG. 1. Alternatively or additionally, some of all of the operations may be performed by another system.

In one or more embodiments, the ML configuration engine accesses a visual dataset that includes image data (Operation 200). For example, the ML configuration engine may receive a set of one or more images of a visual dataset from a data repository or another source.

In an embodiment, the ML configuration engine determines a whole image performance using a CVM (Operation 202). For example, the ML configuration engine may determine one or more whole image performance metrics at least by applying the CVM to a set of one or more images of a visual dataset. In one or more embodiments, the ML configuration engine instructs a CVM to perform one or more tasks using one or more whole images, or all of the images, included in the visual dataset. In various embodiments, the ML configuration engine instructs any number of models to perform any number of tasks on any number of whole images. The ML configuration engine determines an accuracy, precision, correctness, F1 score, and/or other performance metric associated with performing the task(s) using the whole image(s).

In an embodiment, the ML configuration engine determines a patch performance metric using the CVM (Operation 204). The ML configuration engine may determine the performance metric at least by applying the CVM to one or more patches of the whole image. Specifically, the ML configuration engine instructs the CVM to perform one or more tasks using patches of one or more whole images at one or more granularities. In various embodiments, the ML configuration engine instructs any number of models to perform any number of tasks on any number of patches of whole images included in the visual dataset. The ML configuration engine determines an accuracy, precision, correctness, F1 score, and/or other performance metric associated with performing the task(s) using the patches. For a particular image, the ML configuration engine may determine a maximum or average performance. The ML configuration engine may determine a maximum patch performance by identifying the highest performance metric among patch-specific performance metrics associated with an image. Additionally or alternatively, the ML configuration engine may determine an average patch performance for a given patch location across a set of images, and/or a maximum average patch performance by identifying a location with a highest average patch performance across a set of images.

In an embodiment, the ML configuration engine determines an RCI value as a function of the whole image performance and the patch performance (Operation 206). The ML configuration engine may determine a ratio or score based on a patch performance and a whole image performance for the visual dataset. One or more embodiments calculate an RCI value using the quotient of (a) a maximum (or average) patch performance for one or more patches of an image divided by (b) a performance for the whole version of the image. In this example, the RCI value is defined by subtracting the quotient from unity (e.g., from 1). In various embodiments, the ML configuration engine calculates an aggregated patch performance metric by aggregating (e.g., by determining an average or mean) patch performance metrics. The ML configuration engine calculates an aggregated whole image performance metric by aggregating whole image performance metrics. In this example, the RCI value is defined as the result of subtracting the quotient of the aggregated performance metrics from unity.

In an embodiment, the ML configuration engine determines if the RCI value satisfies a threshold deployment criterion (Operation 208). For example, the ML configuration engine may determine if the RCI value indicates a local or global bias. In this example, the RCI value indicates a local bias if the RCI value is low, such as being negative or near zero (e.g., below 0.2, 0.5, 0.8 or another threshold). The RCI value indicates a global bias if the RCI value is near one (e.g., above 0.8, 0.5, 0.2 or another threshold). In embodiments, the ML configuration engine calculates an RCI value based on relative patch performance and whole image performance for an image or for one or more visual datasets including images.

In an embodiment, the ML configuration engine determines if the RCI value satisfies a threshold deployment criterion that is set for a particular task type or deployment setting. For example, different deployment settings may be configured for performing visual language tasks of different types. An RCI value for a deployment setting related to one or more tasks indicates if a CVM is suitable for being deployed to the deployment setting. For a task type associated with a local bias, the RCI value indicates a local bias if the RCI value is low. For a task type associated with a global bias, the RCI value indicates a global bias if the RCI value is high. One or more embodiments deploy a CVM based on an RCI value indicating a bias that matches a bias for one or more tasks related to the deployment setting.

In an embodiment, the ML configuration engine selects a CVM from a set of CVMs based on an RCI value associated with the CVM being a highest or lowest RCI value for a task type. For example, a global reasoning task (e.g., an autonomous driving, remote sensing, or medical diagnostics) is a type of visual language task associated with a global bias. A local recognition task (e.g., optical character recognition, facial recognition, visual inspection, defect detection) is a task that is associated with a local bias.

In an embodiment, the ML configuration engine selects a CVM for a task type based on an RCI value for the CVM and a specified dataset. In this example, the specified dataset refers to a dataset that includes data items that are related to a task type and/or tasks that are related to a task type. The specified dataset may also refer to an “adversarial” dataset that has been selected, generated, or altered to introduce challenges for the CVM such as noise, distortion, etc. The CVM uses the dataset to perform the tasks with a global, local, task type-specific, and/or other bias.

In an embodiment, if the RCI value does not satisfy the threshold deployment criterion, the ML configuration engine does not deploy the CVM (Operation 210). In this example, a deployment setting associated with an ML pipeline has a reasoning requirement, such as a global reasoning requirement or a local reasoning requirement. If the RCI value indicates a local reasoning bias (e.g., by being lower than a threshold), the ML configuration engine does not deploy a model to a deployment setting with a global reasoning task requirement. Likewise, if the RCI value indicates a global reasoning bias (e.g., by being higher than a threshold), the ML configuration engine does not deploy a model to a deployment setting with a local reasoning task requirement. In embodiments, the RCI value includes an aggregated RCI value that is calculated based on aggregating a model's RCI values for multiple datasets. In other embodiments, the RCI value includes an aggregated RCI value for images in a particular benchmark dataset or training dataset.

Responsive to determining that the RCI value satisfies the threshold deployment criterion, the ML configuration engine deploys the CVM (Operation 212). Specifically, the ML configuration engine deploys the CVM to a target deployment setting responsive to determining that the RCI value meets a criterion for a reasoning requirement for the target deployment setting. Various target deployment settings have reasoning requirements that are met by an RCI value satisfying a threshold criterion. For example, an example deployment setting that includes a local reasoning requirement may require that an RCI value be sufficiently low. In this example, the ML configuration engine deploys the CVM to a deployment setting with a local reasoning requirement responsive to determining that the RCI value is sufficiently low. Conversely, an alternative deployment setting includes a global reasoning requirement that is met by an RCI value being sufficiently high. In this example, the ML configuration engine deploys the CVM to the deployment setting with the global reasoning requirement responsive to determining that the RCI value is sufficiently high.

In some embodiments, the target deployment setting is a deployment setting that is included in or associated with the ML pipeline. In some embodiments, the ML pipeline configuration engine deploys the CVM to the target deployment setting based on the CVM meeting one or more additional criterion, such as a patch performance criterion, a whole image performance criterion, an overall performance criterion, and/or another performance criterion.

In an embodiment, the ML configuration engine determines an RCI value using a different language model (Operation 214). In this example, the ML configuration engine determines an RCI value as a function of (a) a performance metric determined at least by applying the different CVM to the whole image and (b) a patch performance metric determined at least by applying the different CVM to one or more patches of the whole image. In this example, the ML configuration engine determines a ratio or score that is determined based on relative patch performance and whole image performance for one or more images of the visual dataset. One or more embodiments calculate this RCI value by determining the quotient of a maximum (or average) patch performance for the image divided by a performance for the whole image.

One or more embodiments calculate an aggregated patch performance metric by aggregating (e.g., by averaging or calculating a mean) patch performance metrics for a set of images. In addition, one or more embodiments calculate an aggregated whole image performance metric by aggregating whole image performance metrics for a set of images. One or more embodiments calculate an example RCI value by determining the quotient of an aggregated patch performance for the images divided by an aggregated performance for the images.

Additionally or alternatively, one or more embodiments calculate an example RCI value by aggregating quotients. An aggregated quotient is calculated by summing two or more quotients that are defined based on dividing one or more patch performance metrics by one or more image performance metrics. The aggregated quotient is determined by summing the two or more quotients and then dividing by the number of quotients. For example, a quotient that is determined by dividing a patch performance metric by an image performance metric is aggregated with another quotient that is determined by a dividing a patch performance metric by an image performance metric. The quotients are aggregated by dividing the sum of the quotients by the number of quotients to result in an aggregated quotient.

The ML configuration engine selects a CVM based on an RCI value and a reasoning requirement (Operation 216). The ML configuration engine may select a CVM from among multiple candidate CVMs to process a particular type of data based at least on (i) RCI values for the candidate CVMs and (ii) one or more relative global and/or localized reasoning requirements for the particular type of data. For example, the one or more relative global and/or localized reasoning requirements for the particular type of data may include a global or local reasoning requirement. The particular type of data includes globally-biased or local-biased data. Global-biased data is better suited to global reasoning, whereas local-biased data is better suited to local reasoning. In this example, if the particular type of data is local-biased data, the ML configuration engine selects the CVM with the lower corresponding RCI value. If the particular type of data is global-biased data, the ML configuration engine selects the CVM that has a higher or highest corresponding RCI value.

The ML configuration engine determines if an RCI value satisfies a threshold training and/or benchmarking criterion (Operation 218). In this example, the ML configuration engine compares one or more RCI values to a threshold training and/or benchmarking criterion. Based on the criterion, one or more embodiments determine whether or not to include a data item in a benchmarking dataset and/or a training dataset. Depending on the type of the training and/or benchmarking data, the criterion may be an upper bound requirement or lower bound requirement that is used to determine if visual data is global-biased or local-biased. For example, if an RCI value for the visual dataset is near one, the visual dataset satisfies a threshold criterion for being included in a training and/or benchmarking dataset for a deployment setting with a global requirement. Conversely, if an RCI value for a visual dataset is negative or near zero, the visual dataset satisfies a threshold criterion for being included in a training and/or benchmarking dataset for a deployment setting having a local requirement.

One or more embodiments compute an aggregate RCI value by aggregating RCI values calculated from results of a CVM performing a set of tasks using a particular visual dataset. For example, the ML configuration engine may combine RCI values for multiple CVMs to generate a final RCI value for the particular visual dataset. One or more embodiments aggregate or otherwise combine the RCI values to generate a final RCI value associated with the visual dataset and the one or more CVMs.

If no RCI value satisfies the threshold training and/or benchmarking criterion, the ML configuration engine does not use the visual dataset as training data or benchmark data (Operation 220). If the RCI value does not satisfy the training and/or benchmarking criterion, one or more embodiments may retain, discard, or modify the visual data.

If an RCI value does satisfy the threshold training and/or benchmarking criterion, the ML configuration engine selects the visual dataset as benchmarking or training data (Operation 222). The ML configuration engine may select the visual dataset for a target CVM for benchmarking and/or training the target CVM in the ML pipeline responsive to determining that an RCI value satisfies the threshold training and/or benchmarking criterion.

For example, a threshold training and/or benchmarking criterion may be satisfied if an RCI value is above a specified value. One or more embodiments include a data item in a training or benchmarking dataset, used to train and/or benchmark a target CVM for a global deployment setting, contingent on the data item satisfying the threshold criterion. In this context, a global deployment setting refers to a setting that processes a type of data that has a global reasoning bias. The ML configuration engine selects the visual data item responsive to determining that an RCI value for the visual data item is above the specified value for the global deployment setting. In another example, another threshold training and/or benchmarking criterion is satisfied if an RCI value is below a specified value as a requirement for inclusion in a training or benchmarking dataset used to train and/or benchmark a target CVM for a local deployment setting.

In one or more embodiments, a threshold training and/or benchmarking criterion is satisfied if an RCI value for a visual dataset is above another RCI value for another visual dataset. One or more embodiments include the visual dataset in a training or benchmarking dataset, used to train and/or benchmark a target CVM for a target deployment setting, contingent on the threshold criterion being satisfied. In one or more embodiments, a threshold training and/or benchmarking criterion is satisfied if an RCI value for a visual dataset is below another RCI value for another visual dataset. One or more embodiments include the visual dataset in a training or benchmarking dataset, used to train and/or benchmark a target CVM for a target deployment setting, contingent on the visual dataset satisfying the threshold criterion.

The ML configuration engine determines if the target CVM satisfies a performance criterion (Operation 224). In this example, a benchmark dataset includes data items used for tasks performed by CVMs. Satisfying the performance criterion for the benchmark dataset indicates that the CVM is likely to perform sufficiently well for the intended type(s) of data and/or task(s). The benchmark dataset includes data items having RCI values within a certain value range. For example, one or more embodiments may construct the benchmark dataset from data items for which the respective RCI values meet or exceed a particular threshold value associated with the intended type(s) of data and/or task(s) (e.g., data and/or tasks with a particular reasoning requirement). Alternatively or additionally, one or more embodiments construct a benchmark dataset from data items that are below a particular threshold RCI value. Alternatively, a benchmark dataset itself may satisfy an RCI threshold criterion if an aggregate RCI value for the data items in the benchmark dataset is above or below a particular threshold value.

One or more embodiments deploy the target CVM to a target deployment setting selectively based on how well the model performs using a benchmark dataset that satisfies the specified RCI threshold criterion. The ML configuration engine determines a performance metric, such as accuracy, F1 score, or the like, for the target CVM when performing certain tasks using the benchmark dataset. In an embodiment, the ML configuration engine determines the performance of the target CVM when performing one or more tasks having a reasoning requirement (e.g., local or global) that corresponds to a reasoning requirement type for the target deployment setting. For example, the ML configuration engine may construct a benchmark dataset having an RCI value indicating a strong bias (e.g., local or global) corresponding to the reasoning requirement (e.g., local or global) required by the target deployment setting.

If the performance criterion is not satisfied, the ML configuration engine does not deploy the target CVM (Operation 226). In this example, a target deployment setting includes a reasoning requirement that indicates a local or global bias. The ML configuration engine constructs a benchmark dataset such that the benchmark dataset has a local or global bias. In a deployment setting has a local bias, the ML configuration engine determines a performance of the target CVM on a benchmark dataset for which the RCI value also indicates local bias (e.g., for which the RCI value is near zero or negative). One or more embodiments do not deploy the target CVM if the performance does not meet one or more criteria. In this case, one or more embodiments may save, retrain, or discard the target CVM.

Responsive to determining that the performance criterion is satisfied, the ML configuration engine deploys the target CVM to the target deployment setting (Operation 228). In this example, the ML configuration engine constructs a benchmark dataset including one or more data items meeting a threshold RCI requirement. Continuing the example, the ML configuration engine sorts data items with a high RCI value into a dataset and sorts data items with a low RCI value into another dataset. In some embodiments, the ML configuration engine sorts data items with an RCI value between high RCI values and low RCI values into a third dataset. In some embodiments, the ML configuration engine sorts the data items into one or more additional datasets based on one or more additional thresholds.

In an embodiment, the ML configuration engine measures a performance of the target CVM for one or more tasks that are performed using a benchmark dataset as a resource. For global reasoning, the benchmark dataset includes data items that have a high (or very high) RCI value. For local reasoning, the benchmark dataset includes data items that have a low (or very low) RCI value. For example, the ML configuration engine may deploy the target CVM to a deployment setting in which tasks have global reasoning requirements, responsive to determining that a threshold performance (e.g., 95% accuracy, or higher or lower) is met for a benchmark dataset including data items having an RCI value over 0.9. Alternatively, the ML configuration engine may deploy the target CVM to a local reasoning task deployment setting responsive to a threshold performance being met for a benchmark dataset including data items having an RCI value under 0.2. In various embodiments, the ML configuration engine uses one or more higher or lower RCI thresholds and/or performance thresholds.

### 5. Example Performance Metrics for ML Pipeline Configuration System

Detailed examples are described below for purposes of clarity. Components and/or operations described below should be understood as specific examples that may not be applicable to certain embodiments. Accordingly, components and/or operations described below should not be construed as limiting the scope of any of the claims.

### 5.1. Performance Metrics

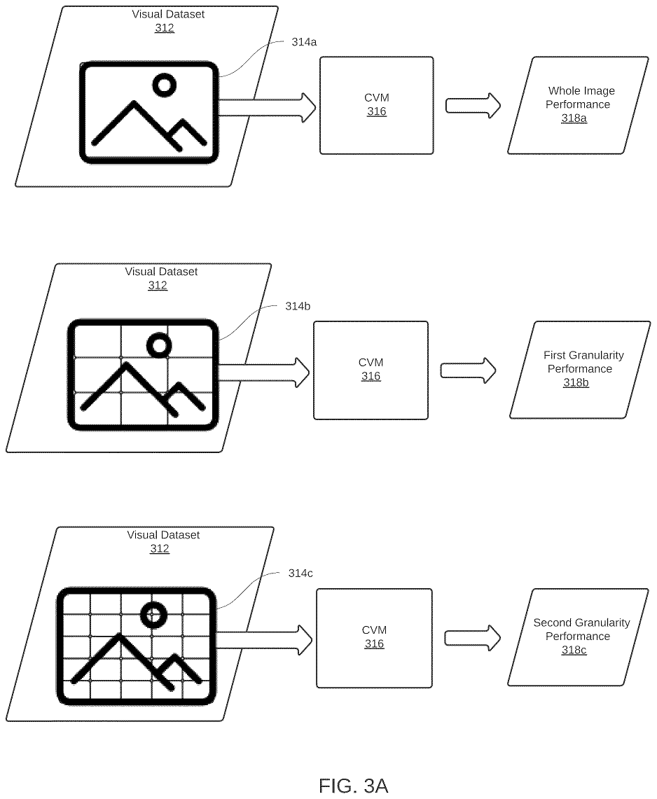

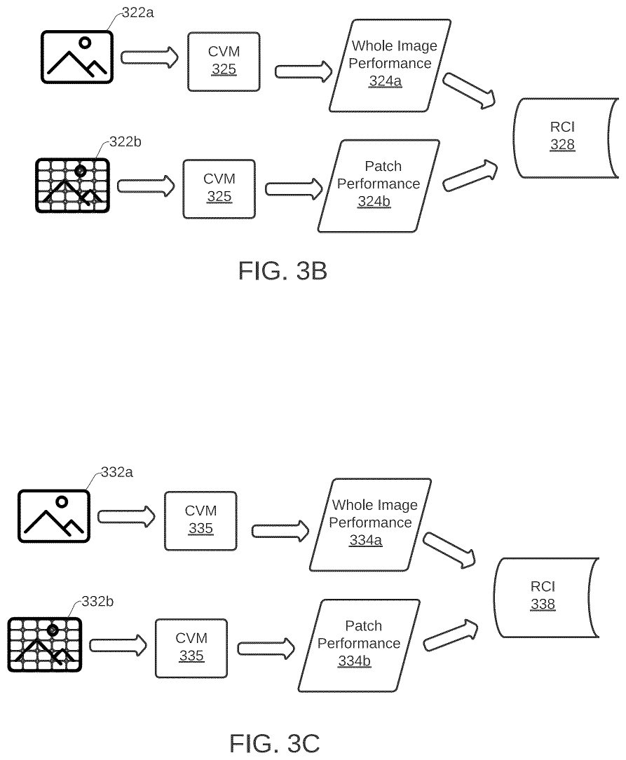

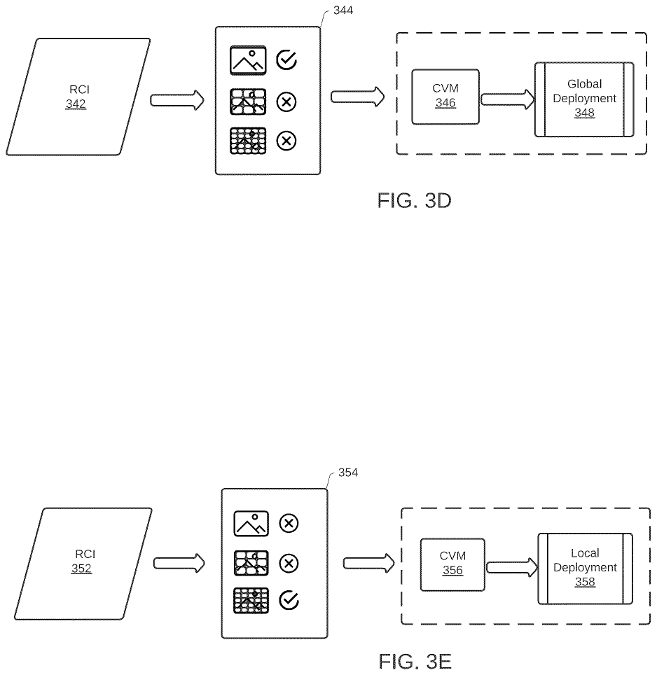

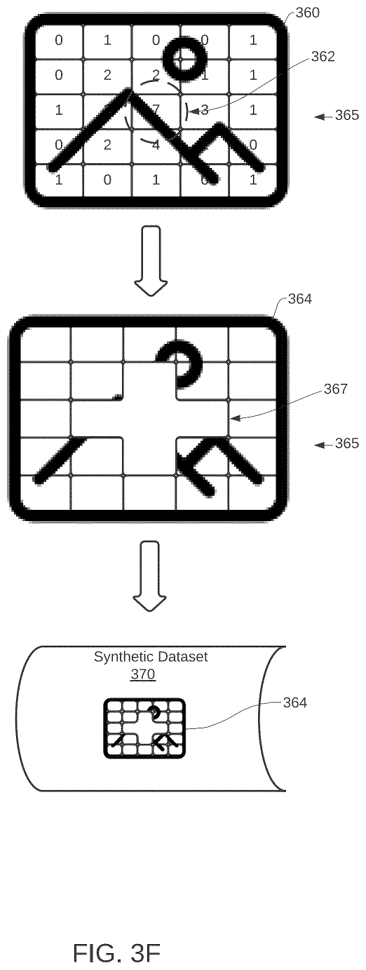

FIG. 3A illustrates an example of determining performance metrics from an image and from patches of the image at different granularities. In FIG. 3A, the ML configuration engine generates a performance metric from a visual data item included in a visual dataset 312. In FIG. 3A, the ML configuration engine determines performance metrics for the visual data item at different granularities. In the example, the different granularities include a whole image version 314a of the image, a nine-patch granularity version 314b, and a twenty-five-patch (25-patch) granularity version 314c.

The ML configuration engine uses a CVM 316 to generate a whole image performance metric 318a based on the whole image version 314a of an image included in the visual dataset. In the example, the ML configuration engine also uses the CVM 316 to generate a first granularity performance metric 318b that is based on the nine-patch granularity version 314b of the image, and the ML configuration engine generates a second granularity performance 318c for the CVM 316 that is based on the 25-patch granularity version 314c of the image.

The CVM 316 performs one or more tasks using the whole image version 314a of the image and the nine-patch granularity version 314b and/or the 25-patch granularity version 314c. The ML configuration engine evaluates a response generated by the CVM 316 for a task using the whole image version 314a to determine a metric (e.g., accuracy, F1 score, etc.) that is used to calculate the whole image performance 318a. The ML configuration engine evaluates a response generated by the CVM 316 for a task using the nine-patch granularity version 314b to determine a metric that is used to calculate the first granularity performance 318b. The ML configuration engine evaluates a response generated by the CVM 316 for a task using the 25-patch granularity version 314c to determine a metric that is used to calculate the second granularity performance 318c.

### 5.2. Examples of RCIs

FIG. 3B illustrates an example RCI value calculation for a CVM 325. In FIG. 3B, a whole image version 322a of an image is input into the CVM 325. The ML configuration engine analyzes an output of the CVM 325 to determine an accuracy, correctness, or the like, to obtain a whole image performance 324a.

Also in FIG. 3B, a first granularity version 322b of the image is input into the CVM 325. The ML configuration engine analyzes the output of the CVM 325 to obtain a patch performance 324b.

The ML configuration engine calculates an RCI value 328 using the whole image performance 324a and the patch performance 324b. In this example, the ML pipeline configuration engine calculates an index for relative global or local bias by determining a quotient of the patch performance 324b divided by the whole image performance 324a.

In an embodiment, the ML pipeline configuration engine generates an aggregate RCI value by aggregating or otherwise combining multiple RCI values. The different RCI values are determined based on analyzing outputs of different CVMs. An RCI value is calculated using multiple whole image performances and patch performances for multiple CVMs based on scores for tasks performed by the models using the image and performed by the models using patches of the image.

FIG. 3C illustrates an example RCI value calculation for a CVM 335. In FIG. 3C, a whole image version 332a of an image is input into the CVM 335. The ML configuration engine analyzes an output of the CVM 335 to determine an accuracy, correctness, or the like, to obtain a whole image performance 334a.

Also in FIG. 3C, a first granularity version 332b of the image is input into the CVM 335. The ML configuration engine analyzes the output of the CVM 335 to obtain a patch performance 334b.

The ML configuration engine calculates an RCI value 338 using the whole image performance 334a and the patch performance 334b. In this example, the ML pipeline configuration engine calculates an index for relative global or local bias by determining a quotient of the patch performance metric 334b divided by the whole image performance 334a.

In an embodiment, the ML pipeline configuration engine generates an aggregate RCI value by aggregating or otherwise combining RCI values. The ML pipeline configuration engine determines aggregate RCI values based on multiple outputs of a particular CVM that were output in response to multiple respective benchmark datasets. The ML pipeline configuration engine calculates an aggregate RCI value using whole image performances and patch performances for the CVM performing tasks using images from the benchmark datasets by generating respective RCI values for the CVM, tasks, and datasets and aggregating (e.g., averaging) the RCI values to obtain the aggregate RCI value. In another example, the ML pipeline configuration engine determines an aggregate RCI value as an aggregate performance for a CVM performing a set of multiple benchmark tasks and/or for a CVM performing tasks using images from a set of benchmark data.

### 5.3. Global Reasoning Deployment

FIG. 3D illustrates an example of deploying a CVM 346 to a global deployment setting 348 with a global reasoning requirement 344. In FIG. 3D, an RCI value 342 satisfies a global reasoning requirement 344 associated with the global deployment setting 348. The ML pipeline configuration engine selects the CVM 346 for the global deployment setting 348 based on the RCI value 342 satisfying the global reasoning requirement 344.

In embodiments, the ML pipeline configuration engine selects a visual dataset or one or more visual data items for inclusion in a training dataset or benchmarking dataset responsive to the RCI value 342 satisfying the global reasoning requirement 344 associated with the global deployment setting 348. In this example, the ML configuration engine trains and/or benchmarks the CVM 346 for the global deployment setting 348 using the visual data item(s) as training and/or benchmarking data. Responsive to the CVM 346 meeting a performance criterion for the visual data item(s), the ML pipeline configuration engine deploys the CVM 346 to the global deployment setting 348.

### 5.4. Local Reasoning Deployment

FIG. 3E illustrates an example of deploying a CVM 356 to a local deployment setting 358 with a local reasoning requirement 354. In FIG. 3E, an RCI value 352 satisfies a local reasoning requirement 354 associated with a local reasoning deployment setting 358. The ML pipeline configuration engine selects the CVM 356 for the local reasoning deployment setting 358 based on the RCI value 352 satisfying the local reasoning requirement 354.

In embodiments, the ML pipeline configuration engine selects a visual dataset or one or more visual data items for inclusion in a training dataset or benchmarking dataset responsive to the RCI value 352 satisfying the local reasoning requirement 354 associated with the local reasoning deployment setting 358. In this example, the ML configuration engine trains and/or benchmarks the CVM 356 for the local reasoning deployment setting 358 using the visual data item(s) as training and/or benchmarking data. Responsive to the CVM 356 meeting a performance criterion for the visual data item(s), the ML pipeline configuration engine deploys the CVM 356 to the local reasoning deployment setting 358.

### 5.5. Synthetic Dataset Construction

FIG. 3F illustrates an example of synthetic dataset construction and visual data item processing. In FIG. 3F, a heatmap 360 of an image 365 at a first granularity indicates the number of times patch locations were highest-performing based on outputs from a CVM in response to tasks using the image patches. In the example, a central patch 362 has the greatest number of times of being the best-performing patch. Patches with a high number or frequency of being the best-performing patch are considered to be important or critical patches. Additionally, or alternatively, a patch with a high average performance is also considered important or critical. In some embodiments, the ML pipeline configuration engine determines a regional bias (e.g., an index or score) according to a relative performance for a particular selection of patches or region of patches of the heatmap to identify a regional bias other than local or global, such as right-bias, top-bias, corner-bias, central-bias, perimeter-bias, etc. Such indexes are determined based on a quotient of (a) a performance for a selection of patches corresponding to the type of bias divided by (b) a whole image performance.

Masking (e.g., covering or distorting) a critical or important patch often affects performance metrics and resulting RCI values. For example, covering a best-performing patch location forces a model to rely on information in another patch location that did not perform as well. Accordingly, the quotient of patch performance divided by whole image performance is reduced, and the resulting RCI value is increased. Conversely, adding noise to patch locations that are not important or critical obfuscates global information without reducing the performance for the best patch. Accordingly, the quotient of patch performance divided by whole image performance is increased, and the resulting RCI value is decreased.

In another example, a task is solvable by processing a single patch location of an image and also by processing multiple different patch locations of the image. Masking the single patch in this example results in the task requiring more than one patch, which increases the global reasoning requirement. In another example, a task is solvable by processing a single patch of an image and also by processing multiple different patches of the image. In this example, masking one or more of the multiple different patches of the image results in the task requiring the single patch, which increases the local reasoning requirement.

On or more embodiments generate synthetic datasets with a high RCI value by constructing visual data items in the visual dataset for which information that is helpful or needed to perform a task is spread across multiple patch locations. Alternatively or additionally, one or more embodiments generate synthetic datasets with a low RCI value by constructing visual data items in the synthetic dataset for which information that is helpful or needed to perform a task is isolated in a patch location.

In some embodiments, the ML pipeline configuration engine selectively and/or incrementally masks, noises, distorts, rotates, or otherwise manipulates one or more patch locations on one or more visual data items in a visual dataset to result in a synthetic dataset that satisfies an RCI criterion (e.g., has an RCI value above or below a threshold value). In FIG. 3F, a masked version 364 of the image 365 includes a mask 367 that covers several patch locations, including the central patch location 362 and other patch locations that were previously used or helpful for completing tasks. As a result, when a CVM performs tasks on the whole image and patches of the masked version 364 of image 365, an RCI value calculated based on the result is higher than when the CVM performs the tasks on the image 365 without the mask 367.

### 6. ML Architecture

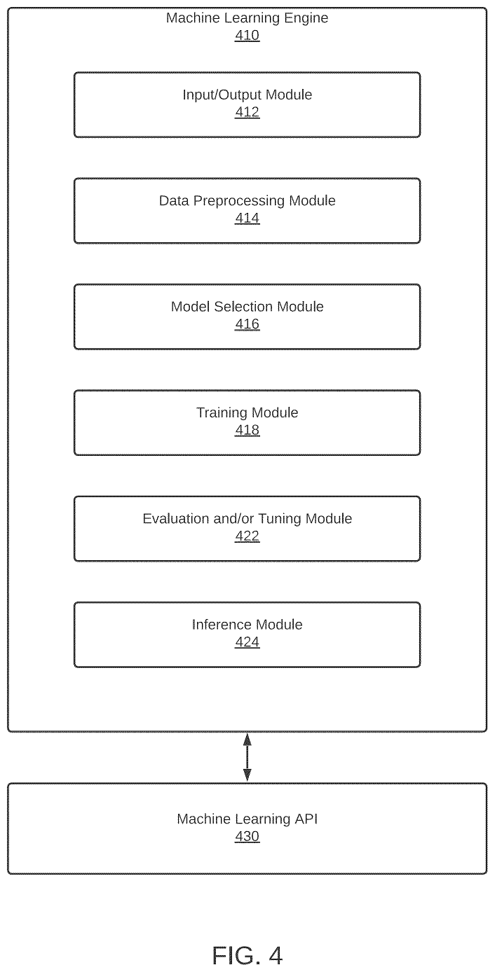

FIG. 4 illustrates a ML engine 410 in accordance with one or more embodiments. As illustrated in FIG. 4, ML engine 410 includes input/output module 412, data preprocessing module 414, model selection module 416, training module 418, evaluation and/or tuning module 422, and inference module 424.

In accordance with an embodiment, input/output module 412 serves as the primary interface for data entering and exiting the system, managing the flow and integrity of data. This module may accommodate a wide range of data sources and formats to facilitate integration and communication within the ML architecture.

In an embodiment, an input handler within input/output module 412 includes a data ingestion framework capable of interfacing with various data sources, such as databases, Application Programming Interfaces (API) s, file systems, and real-time data streams. This framework is equipped with functionalities to handle different data formats (e.g., CSV, JSON, XML) and efficiently manage large volumes of data. It includes mechanisms for batch and real-time data processing that enable the input/output module 412 to be versatile in different operational contexts whether processing historical datasets or streaming data.

In accordance with an embodiment, input/output module 412 manages data integrity and quality as it enters the system by incorporating initial checks and validations. These checks and validations ensure that incoming data meets predefined quality standards, like checking for missing values, ensuring consistency in data formats, and verifying data ranges and types. This proactive approach to data quality minimizes potential errors and inconsistencies in later stages of the ML process.

In an embodiment, an output handler within input/output module 412 includes an output framework designed to handle the distribution and exportation of outputs, predictions, or insights. Using the output framework, input/output module 412 formats these outputs into user-friendly and accessible formats, such as reports, visualizations, or data files, compatible with other systems. Input/output module 412 also ensures secure and efficient transmission of these outputs to end-users or other systems in an embodiment and may employ encryption and secure data transfer protocols to maintain data confidentiality.

In accordance with an embodiment, data preprocessing module 414 transforms data into a format suitable for use by other modules in ML engine 410. For example, data preprocessing module 414 may transform raw data into a normalized or standardized format suitable for training ML models and for processing new data inputs for inference. In an embodiment, data preprocessing module 414 acts as a bridge between the raw data sources and the analytical capabilities of ML engine 410.

In an embodiment, data preprocessing module 414 begins by implementing a series of preprocessing steps to clean, normalize, and/or standardize the data. This involves handling a variety of anomalies, such as managing unexpected data elements, recognizing inconsistencies, or dealing with missing values. Some of these anomalies can be addressed through methods, like imputation or removal of incomplete records, depending on the nature and volume of the missing data. Data preprocessing module 414 may be configured to handle anomalies in different ways, depending on context. Data preprocessing module 414 also handles the normalization of numerical data in preparation for use with models sensitive to the scale of the data, like neural networks and distance-based algorithms. Normalization techniques, such as min-max scaling or z-score standardization, may be applied to bring numerical features to a common scale, enhancing the model's ability to learn effectively.

In an embodiment, data preprocessing module 414 includes a feature encoding framework that ensures categorical variables are transformed into a format that can be easily interpreted by ML algorithms. Techniques, such as one-hot encoding or label encoding, may be employed to convert categorical data into numerical values, making them suitable for analysis. The module may also include feature selection mechanisms, where redundant or irrelevant features are identified and removed, thereby increasing the efficiency and performance of the model.

In accordance with an embodiment, when data preprocessing module 414 processes new data for inference, data preprocessing module 414 replicates the same preprocessing steps to ensure consistency with the training data format. This helps to avoid discrepancies between the training data format and the inference data format, thereby reducing the likelihood of inaccurate or invalid model predictions.

In an embodiment, model selection module 416 includes logic for determining the most suitable algorithm or model architecture for a given dataset and problem. This module operates in part by analyzing the characteristics of the input data, such as its dimensionality, distribution, and the type of problem (classification, regression, clustering, etc.).

In an embodiment, model selection module 416 employs a variety of statistical and analytical techniques to understand data patterns, identify potential correlations, and assess the complexity of the task. Based on this analysis, it then matches the data characteristics with the strengths and weaknesses of various available models. This can range from simple linear models for less complex problems to sophisticated deep learning architectures for tasks requiring feature extraction and high-level pattern recognition, such as image and speech recognition.

In an embodiment, model selection module 416 utilizes techniques from the field of Automated Machine Learning (AutoML). AutoML systems automate the process of model selection by rapidly prototyping and evaluating multiple models. They use various techniques, like Bayesian optimization, genetic algorithms, or reinforcement learning, to explore the model space efficiently. Model selection module 416 may use these techniques to evaluate each candidate model based on performance metrics relevant to the task. For example, accuracy, precision, recall, or F1 score may be used for classification tasks, and mean squared error metrics may be used for regression tasks. Accuracy measures the proportion of correct predictions (both positive and negative). Precision measures the proportion of actual positives among the predicted positive cases. Recall (also known as sensitivity) evaluates how well the model identifies actual positives. F1 Score is a single metric that accounts for both false positives and false negatives. The mean squared error (MSE) metric may be used for regression tasks. Mean squared error measures the average squared difference between the actual and predicted values, providing an indication of the model's accuracy. A lower MSE may indicate a model's greater accuracy in predicting values, for it represents a smaller average discrepancy between the actual and predicted values.

In accordance with an embodiment, model selection module 416 also considers computational efficiency and resource constraints. This is meant to help ensure the selected model is both accurate and practical in terms of computational and time requirements. In an embodiment, certain features of model selection module 416 are configurable such as a configured bias toward (or against) computational efficiency.

In accordance with an embodiment, training module 418 manages the ‘learning’ process of ML models by implementing various learning algorithms that enable models to identify patterns and make predictions or decisions based on input data. In an embodiment, the training process begins with the preparation of the dataset after preprocessing; this involves splitting the data into training and validation sets. The training set is used to teach the model, while the validation set is used to evaluate its performance and adjust parameters accordingly. Training module 418 handles the iterative process of feeding the training data into the model, adjusting the model's internal parameters (like weights in neural networks) through backpropagation and optimization algorithms, such as stochastic gradient descent or other algorithms providing similarly useful results.

In accordance with an embodiment, training module 418 manages overfitting, where a model learns the training data too well, including its noise and outliers, at the expense of its ability to generalize to new data. Techniques, such as regularization, dropout (in neural networks), and early stopping, are implemented to mitigate this. Additionally, the module employs various techniques for hyperparameter tuning; this involves adjusting model parameters that are not directly learned from the training process, such as learning rate, the number of layers in a neural network, or the number of trees in a random forest.

In an embodiment, training module 418 includes logic to handle different types of data and learning tasks. For instance, it includes different training routines for supervised learning (where the training data comes with labels) and unsupervised learning (without labeled data). In the case of deep learning models, training module 418 also manages the complexities of training neural networks that include initializing network weights, choosing activation functions, and setting up neural network layers.

In an embodiment, evaluation and/or tuning module 422 incorporates dynamic feedback mechanisms and facilitates continuous model evolution to help ensure the system's relevance and accuracy as the data landscape changes. Evaluation and/or tuning module 422 conducts a detailed evaluation of a model's performance. This process involves using statistical methods and a variety of performance metrics to analyze the model's predictions against a validation dataset. The validation dataset, distinct from the training set, is instrumental in assessing the model's predictive accuracy and its capacity to generalize beyond the training data. The module's algorithms meticulously dissect the model's output, uncovering biases, variances, and the overall effectiveness of the model in capturing the underlying patterns of the data.

In an embodiment, evaluation and/or tuning module 422 performs continuous model tuning by using hyperparameter optimization. Evaluation and/or tuning module 422 performs an exploration of the hyperparameter space using algorithms, such as grid search, random search, or more sophisticated methods like Bayesian optimization. Evaluation and/or tuning module 422 uses these algorithms to iteratively adjust and refine the model's hyperparameters—settings that govern the model's learning process but are not directly learned from the data—to enhance the model's performance. This tuning process helps to balance the model's complexity with its ability to generalize and attempts to avoid the pitfalls of underfitting or overfitting.

In an embodiment, evaluation and/or tuning module 422 integrates data feedback and updates the model. Evaluation and/or tuning module 422 actively collects feedback from the model's real-world applications, an indicator of the model's performance in practical scenarios. Such feedback can come from various sources, depending on the nature of the application. For example, in a user-centric application, like a recommendation system, feedback might include user interactions, preferences, and responses. In other contexts, such as predicting events, it might involve analyzing the model's prediction errors, misclassifications, or other performance metrics in live settings.

In an embodiment, feedback integration logic within evaluation and/or tuning module 422 integrates this feedback using a process of assimilating new data patterns, user interactions, and error trends into the system's knowledge base. The feedback integration logic uses this information to identify shifts in data trends or emergent patterns that were not present or inadequately represented in the original training dataset. Based on this analysis, the module triggers a retraining or updating cycle for the model. If the feedback suggests minor deviations or incremental changes in data patterns, the feedback integration logic may employ incremental learning strategies, fine-tuning the model with the new data while retaining its previously learned knowledge. In cases where the feedback indicates significant shifts or the emergence of new patterns, a more comprehensive model updating process may be initiated. This process might involve revisiting the model selection process, re-evaluating the suitability of the current model architecture, and/or potentially exploring alternative models or configurations that are more attuned to the new data.

In accordance with an embodiment, throughout this iterative process of feedback integration and model updating, evaluation and/or tuning module 422 employs version control mechanisms to track changes, modifications, and the evolution of the model, facilitating transparency and allowing for rollback if necessary. This continuous learning and adaptation cycle, driven by real-world data and feedback, helps to endure the model's ongoing effectiveness, relevance, and accuracy.

In an embodiment, inference module 424 transforms raw data into actionable, precise, and contextually relevant predictions. In addition to processing and applying a trained model to new data, inference module 424 may also include post-processing logic that refines the raw outputs of the model into meaningful insights.

In an embodiment, inference module 424 includes classification logic that takes the probabilistic outputs of the model and converts them into definitive class labels. This process involves an analytical interpretation of the probability distribution for each class. For example, in binary classification, the classification logic may identify the class with a probability above a certain threshold, but classification logic may also consider the relative probability distribution between classes to create a more nuanced and accurate classification.

In an embodiment, inference module 424 transforms the outputs of a trained model into definitive classifications. Inference module 424 employs the underlying model as a tool to generate probabilistic outputs for each potential class. It then engages in an interpretative process to convert these probabilities into concrete class labels.

In an embodiment, when inference module 424 receives the probabilistic outputs from the model, it analyzes these probabilities to determine how they are distributed across some or every potential class. If the highest probability is not significantly greater than the others, inference module 424 may determine that there is ambiguity or interpret this as a lack of confidence displayed by the model.

In an embodiment, inference module 424 uses thresholding techniques for applications where making a definitive decision based on the highest probability might not suffice due to the critical nature of the decision. In such cases, inference module 424 assesses if the highest probability surpasses a certain confidence threshold that is predetermined based on the specific requirements of the application. If the probabilities do not meet this threshold, inference module 424 may flag the result as uncertain or defer the decision to a human expert. Inference module 424 dynamically adjusts the decision thresholds based on the sensitivity and specificity requirements of the application, subject to calibration for balancing the trade-offs between false positives and false negatives.

In accordance with an embodiment, inference module 424 contextualizes the probability distribution against the backdrop of the specific application. This involves a comparative analysis, especially in instances where multiple classes have similar probability scores, to deduce the most plausible classification. In an embodiment, inference module 424 may incorporate additional decision-making rules or contextual information to guide this analysis, ensuring that the classification aligns with the practical and contextual nuances of the application.

In regression models, where the outputs are continuous values, inference module 424 may engage in a detailed scaling process in an embodiment. Outputs, often normalized or standardized during training for optimal model performance, are rescaled back to their original range. This rescaling involves recalibration of the output values using the original data's statistical parameters, such as mean and standard deviation, ensuring that the predictions are meaningful and comparable to the real-world scales they represent.

In an embodiment, inference module 424 incorporates domain-specific adjustments into its post-processing routine. This involves tailoring the model's output to align with specific industry knowledge or contextual information. For example, in financial forecasting, inference module 424 may adjust predictions based on current market trends, economic indicators, or recent significant events, ensuring that the outputs are both statistically accurate and practically relevant.

In an embodiment, inference module 424 includes logic to handle uncertainty and ambiguity in the model's predictions. In cases where inference module 424 outputs a measure of uncertainty, such as in Bayesian inference models, inference module 424 interprets these uncertainty measures by converting probabilistic distributions or confidence intervals into a format that can be easily understood and acted upon. This provides users with both a prediction and an insight into the confidence level of that prediction. In an embodiment, inference module 424 includes mechanisms for involving human oversight or integrating the instance into a feedback loop for subsequent analysis and model refinement.

In an embodiment, inference module 424 formats the final predictions for end-user consumption. Predictions are converted into visualizations, user-friendly reports, or interactive interfaces. In some systems, like recommendation engines, inference module 424 also integrates feedback mechanisms, where user responses to the predictions are used to continually refine and improve the model, creating a dynamic, self-improving system.

The ML engine API 430 is an interface that facilitates access to and interaction with the ML engine 410 by other modules and/or components of a system. In an embodiment, ML engine API 430 allows for applications to leverage ML engine 410. In an embodiment, ML engine API 430 may be built on a RESTful architecture and offer stateless interactions over standard HTTP/HTTPS protocols. Machine learning engine API 430 may feature a variety of endpoints, each tailored to a specific function within ML engine 410. In an embodiment, endpoints such as “/submitData” facilitate the submission of new data for processing, while endpoints such as “/retrieveResults” fetch the outcomes of data analysis or model predictions. Message level encryption (MLE) API also includes endpoints, such as “/updateModel” for model modifications and “/trainModel” to initiate training with new datasets.

In an embodiment, ML engine API 430 is equipped to support SOAP-based interactions. This extension involves defining a Web Services Description Language (WSDL) document that outlines the API's operations and the structure of request and response messages. In an embodiment, ML engine API 430 supports various data formats and communication styles. In an embodiment, ML engine API 430 endpoints may handle requests in JSON format or any other suitable format. For example, ML engine API 430 may process XML, and it may also be engineered to handle more compact and efficient data formats, such as Protocol Buffers or Avro, for use in bandwidth-limited scenarios.

In an embodiment, ML engine API 430 is designed to integrate WebSocket technology for applications necessitating real-time data processing and immediate feedback. This integration enables a continuous, bi-directional communication channel for a dynamic and interactive data exchange between the application and ML engine 410.

### 7. ML Operations

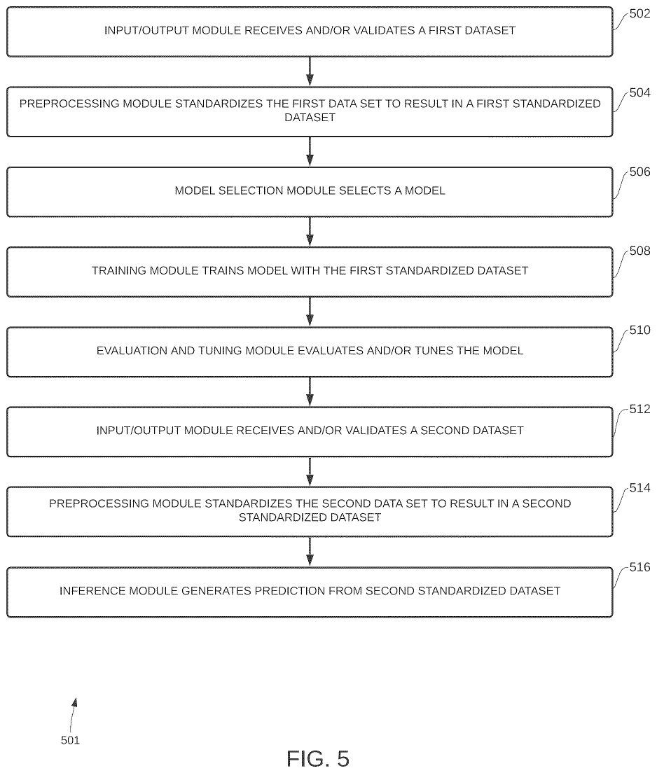

FIG. 5 illustrates a set of ML operations 501. In embodiments, one or more operations of the set of operations 500 is performed by an ML engine such as ML engine 410. In an embodiment, input/output module 412 receives a dataset intended for training (Operation 502). This data can originate from diverse sources, like databases or real-time data streams, and in varied formats, such as CSV, JSON, or XML. Input/output module 412 assesses and validates the data, ensuring its integrity by checking for consistency, data ranges, and types.

In an embodiment, training data is passed to data preprocessing module 414. Here, the data undergoes a series of transformations to standardize and clean it, making it suitable for training ML models (Operation 504). This involves normalizing numerical data, encoding categorical variables, and handling missing values through techniques like imputation.

In an embodiment, prepared data from the data preprocessing module 414 is then fed into model selection module 416 (Operation 506). This module analyzes the characteristics of the processed data, such as dimensionality and distribution, and selects the most appropriate model architecture for the given dataset and problem. It employs statistical and analytical techniques to match the data with an optimal model, ranging from simpler models for less complex tasks to more advanced architectures for intricate tasks.

In an embodiment, training module 418 trains the selected model with the prepared dataset (Operation 508). It implements learning algorithms to adjust the model's internal parameters, optimizing them to identify patterns and relationships in the training data. Training module 418 also addresses the challenge of overfitting by implementing techniques, like regularization and early stopping, ensuring the model's generalizability.

In an embodiment, evaluation and/or tuning module 422 evaluates the trained model's performance using the validation dataset (Operation 510). Evaluation and/or tuning module 422 applies various metrics to assess predictive accuracy and generalization capabilities. It then tunes the model by adjusting hyperparameters, and if needed, incorporates feedback from the model's initial deployments, retraining the model with new data patterns identified from the feedback.

In an embodiment, input/output module 412 receives a dataset intended for inference. Input/output module 412 assesses and validates the data (Operation 512).

In an embodiment, data preprocessing module 414 receives the validated dataset intended for inference (Operation 514). Data preprocessing module 414 ensures that the data format used in training is replicated for the new inference data, maintaining consistency and accuracy for the model's predictions.

In an embodiment, inference module 424 processes the new data set intended for inference, using the trained and tuned model (Operation 516). It applies the model to this data, generating raw probabilistic outputs for predictions. Inference module 424 then executes a series of post-processing steps on these outputs, such as converting probabilities to class labels in classification tasks or rescaling values in regression tasks. It contextualizes the outputs as per the application's requirements, handling any uncertainty in predictions and formatting the final outputs for end-user consumption or integration into larger systems.

### 8. Generative Artificial Intelligence Models

A generative model is an ML model that is capable of generating new data instances based on the data used to train the model. A generative model may be referred to as a “generative AI model.” Generative models learn the underlying distribution of the training data, enabling them to produce new instances of data that share properties with the original dataset. This capability makes them particularly useful in a variety of applications, including image and voice generation, text synthesis, and more sophisticated tasks, such as unsupervised learning, semi-supervised learning, and domain adaptation.

Large language models are designed to understand, generate, and interpret human language by processing extensive collections of data. The foundational architecture behind LLMs is the transformer network, a type of neural network that excels in handling sequential data such as text. Unlike certain architectures, such as recurrent neural networks (RNNs) or long short-term memory networks (LSTMs), transformers do not process data in order. Instead, they leverage parallel processing to analyze entire text sequences simultaneously, significantly improving efficiency and reducing training times.

In an embodiment, a mechanism that enables transformers to handle complex language tasks is self-attention. This mechanism allows the model to weigh the importance of different words within a sentence or sequence regardless of their position. For instance, in processing the phrase “The cat sat on the mat,” the model can directly associate “cat” with “mat” without having to process the intermediate words sequentially. This ability to understand the context and relationships between words in a sentence is what makes transformer networks adept at language tasks. The self-attention mechanism assigns scores to relationships between words, highlighting the most relevant connections, so the model can focus on the most informative parts of the text.

In accordance with one or more embodiments, transformers are composed of multiple layers including a multi-head, self-attention mechanism and a position-wise, feed-forward network. Within the architecture of transformer models, the multi-head, self-attention mechanism and position-wise, feed-forward network function in concert to process input data. The multi-head, self-attention mechanism is designed to enable parallel processing of input sequences, allowing the model to simultaneously evaluate the importance of different segments of the input relative to each other. This mechanism operates by generating multiple sets of query, key, and value vectors for each element in the input sequence through linear transformation. The relevance of each element to other elements is calculated using a scaled dot-product attention function that computes the attention scores by taking the dot product of the query vector with the key vectors, dividing each by the square root of the dimension of the key vectors to scale the scores, then applying a “SoftMax” function to obtain the weights for the value vectors. The scaled dot-product attention function is applied independently by each head in the multi-head, self-attention mechanism. The outputs of these heads are then concatenated and linearly transformed, allowing the model to capture information from different representation subspaces.

In accordance with one or more embodiments, following the multi-head, self-attention mechanism is the position-wise, feed-forward network. This component comprises two linear transformations with a non-linear activation function in between. Each element of the input sequence, now enriched with context by the self-attention mechanism, is processed independently through the same feed-forward network. The first linear transformation increases the dimensionality of the input, allowing for a richer representation space. The non-linear activation function introduces the capability to capture non-linear relationships within the data. The second linear transformation then reduces the dimensionality back to that of the model's hidden layers, preparing the output for either further processing by subsequent layers or final output generation. This sequence of operations is applied to each position in the sequence, so the model can learn complex patterns across different parts of the input data without relying on the sequential processing inherent to previous architectures, such as RNNs or LSTMs.

In accordance with one or more embodiments, integrating these components within the transformer architecture facilitates the model's ability to understand and generate human language by leveraging both the global context provided by the self-attention mechanism and the local, position-specific transformations applied by the feed-forward networks. Through the repetitive stacking of layers, transformers achieve a depth of representation that allows for the processing of linguistic information across varying levels of complexity.

In accordance with one or more embodiments, input/output module 412, when used for LLMs, handles textual data, converting input text into a format that the model can process. This typically involves tokenization, where the text is broken down into manageable pieces, such as words or subwords, and then converted into numerical representations. These representations, or embeddings, capture semantic information about the text that is then fed into the model for processing. The output from the model is converted from numerical form back into human-readable text, following the generation of predictions or responses.

In accordance with one or more embodiments, data preprocessing module 414 in the context of LLMs may include steps, such as normalization, where the text is converted to a uniform case, and punctuation is standardized. This process ensures that the model treats similar words or symbols consistently, reducing the complexity of the input space. Additionally, techniques, such as sentence segmentation, may be applied to manage longer texts, enabling the model to process information in chunks that align with natural language structures.

In accordance with one or more embodiments, model selection module 416, when used for LLMs, involves choosing a specific architecture and configuration that is best suited to the task at hand. This decision is based on various factors, such as the size of the available training data, the complexity of the language tasks to be performed, and computational resource constraints. Models may vary in size from millions to billions of parameters, with larger models generally capable of more nuanced language understanding and generation but requiring significantly more computational power to train and operate.

In accordance with one or more embodiments, training module 418, when used for LLMs, is configured to adjust the model's parameters through exposure to training data. This process utilizes optimization algorithms, such as stochastic gradient descent, to minimize the difference between the model's predictions and the actual desired outputs. The training process is computationally intensive, often requiring specialized hardware, such as Graphics Processing Units (GPUs) or Tensor Processing Units (TPUs), to manage the large volumes of data and the complexity of the model calculations. During training, techniques, such as dropout and layer normalization, are used to improve model generalization and prevent overfitting (e.g., when a model learns the detail and noise in the training data to the extent that it negatively impacts the model's performance on new data).

In accordance with one or more embodiments, evaluation and/or tuning module 422 assesses the performance of LLMs using metrics, such as perplexity, accuracy, and F1 score, depending on the specific language tasks. Evaluation may involve comparing the model's output against a set of labeled validation data, providing insight into how well the model has learned to perform tasks, such as text classification, question answering, or text generation. Tuning involves adjusting model parameters or training strategies based on evaluation outcomes to improve performance. This may include hyperparameter tuning, where parameters that govern the training process, such as learning rate or batch size, are adjusted.

In accordance with one or more embodiments, inference module 424, in the context of LLMs, is responsible for generating predictions or responses based on new, unseen data. This process involves feeding the input data through the trained model to produce an output. Inference can be used for a variety of applications, including translating text, generating human-like responses in a chatbot, or summarizing articles.

Another type of generative model is a large multimodal model (LMM). An LMM is an advanced ML model capable of processing and generating data across multiple modalities, such as text, images, audio, and video. These models integrate diverse datasets during training to learn the underlying distribution of different data types, enabling them to produce outputs that reflect a comprehensive understanding of the input data. These models can be used for numerous applications, such as image captioning, text-to-image generation, image-to-text generation, visual question answering, and more, where understanding the relationship between different data types is crucial. By leveraging diverse datasets during training, LMMs learn to create coherent and contextually relevant outputs across various modalities, enhancing their utility in complex, real-world scenarios.

The architecture of LLMs combines elements from different neural network designs to handle diverse data types effectively. For example, convolutional neural networks (CNNs) are often used for processing visual data, while transformer networks handle textual data, enabling the model to extract and synthesize features from both images and text. This integration results in outputs that accurately represent the input data, reflecting a deep understanding of both modalities. The transformer architecture, known for its ability to manage sequential data, is frequently adapted to work alongside CNNs, allowing these models to benefit from the strengths of each neural network type.

In at least some instances, the self-attention mechanism, a cornerstone of transformer networks, is integral to the functioning of LMMs. It enables the model to weigh the importance of different elements within an input sequence, regardless of their position, allowing it to capture intricate relationships between various data types. For example, in an image captioning task, the model can associate specific visual features with corresponding descriptive text, enhancing the coherence and accuracy of the generated captions. By assigning scores to relationships between elements, the self-attention mechanism highlights the most relevant connections, enabling the model to focus on the most informative parts of the input data and perform complex multimodal tasks effectively.

In LMMs, data preprocessing is a step that ensures the input data is in a suitable format for the model to process. This involves tasks, such as tokenization for text data, where the text is broken down into manageable pieces, and feature extraction for image data, where key visual elements are identified and encoded. By standardizing and normalizing different data types, preprocessing reduces the complexity of the input space, enabling the model to treat similar elements consistently. Effective preprocessing is essential for the model to integrate information from various modalities and produce accurate, meaningful outputs.

Training LMMs involves optimizing their parameters through exposure to diverse datasets that include paired data from different modalities. This computationally intensive process often requires specialized hardware, like GPUs or TPUs, to manage the large volumes of data and the complexity of the model calculations. Techniques, such as dropout and layer normalization, are employed to improve model generalization and prevent overfitting. By iteratively adjusting the model's parameters, the training process enables the model to learn underlying patterns and relationships within the data, enhancing its ability to generate coherent and contextually relevant outputs across different modalities.

Evaluation and/or tuning of LMMs are conducted using various metrics tailored to the specific tasks they are designed to perform. For example, Bilingual Evaluation Understudy scores are used for text generation tasks, while accuracy is commonly applied for visual recognition tasks to assess performance. Tuning involves adjusting hyperparameters and refining training strategies based on evaluation results to enhance the model's effectiveness. This iterative process ensures that the model can perform a wide range of multimodal tasks with high accuracy and relevance, making it a versatile tool for applications requiring the integration of different types of data.

Large multimodal models represent a significant advancement in ML by leveraging sophisticated architectures that combine different neural network types and apply self-attention mechanisms. This enables them to perform complex tasks that require understanding and synthesizing information from diverse data types. Effective preprocessing, rigorous training, and thorough evaluation are crucial to their success, allowing these models to generate coherent and contextually relevant outputs across a wide range of applications.

In accordance with one or more embodiments, other types of models besides LLMs and LMMs belong to the broad category of generative models. For example, stochastic models directly incorporate randomness into their structure, making them inherently generative, for they can produce a diverse set of outputs for a given input. Generative Adversarial Networks (GANs) learn to generate new data that is indistinguishable from the data they were trained on, using a dual-network architecture that involves a generative component. Variational Autoencoders (VAEs) are designed for generating new data points by learning a distribution of some input data, by encoding inputs into a latent space, and/or by generating outputs by sampling from a latent space. An example VAE is therefore inherently generative. Sequence-to-sequence models are generative in nature when used with sampling strategies. Although this list of generative model types is not exhaustive, it illustrates the broad use of the term generative model beyond LLMs.

Although generative models can be leveraged for classification tasks, they inherently operate on principles of randomness, leading to a spectrum of possible outcomes in response to identical inputs. Unlike deterministic models that yield a consistent result whenever the same input is given, generative models use the randomness in the data they are trained on to both mimic and diversify from the training data. This diversity makes generative models ideal for generating new and varied data points as well as for tasks that require creativity and novelty. However, a reliance on randomness creates a trade-off between predictability and flexibility for generative models, potentially making them less predictable in scenarios where uniform outcomes may be expected such as classification tasks.

### 9. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally, or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally, or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 10. Microservice Applications

According to one or more embodiments, the techniques described herein are implemented in a microservice architecture. A microservice in this context refers to software logic designed to be independently deployable, having endpoints that may be logically coupled to other microservices to build a variety of applications. Applications built using microservices are distinct from monolithic applications, which are designed as a single fixed unit and generally comprise a single logical executable. With microservice applications, different microservices are independently deployable as separate executables. Microservices may communicate using HyperText Transfer Protocol (HTTP) messages and/or according to other communication protocols via API endpoints. Microservices may be managed and updated separately, written in different languages, and be executed independently from other microservices.

Microservices provide flexibility in managing and building applications. Different applications may be built by connecting different sets of microservices without changing the source code of the microservices. Thus, the microservices act as logical building blocks that may be arranged in a variety of ways to build different applications. Microservices may provide monitoring services that notify a microservices manager (such as If-This-Then-That (IFTTT), Zapier, or Oracle Self-Service Automation (OSSA)) when trigger events from a set of trigger events exposed to the microservices manager occur. Microservices exposed for an application may additionally, or alternatively, provide action services that perform an action in the application (controllable and configurable via the microservices manager by passing in values, connecting the actions to other triggers and/or data passed along from other actions in the microservices manager) based on data received from the microservices manager. The microservice triggers and/or actions may be chained together to form recipes of actions that occur in optionally different applications that are otherwise unaware of or have no control or dependency on each other. These managed applications may be authenticated or plugged in to the microservices manager, for example, with user-supplied application credentials to the manager, without requiring reauthentication each time the managed application is used alone or in combination with other applications.

In one or more embodiments, microservices may be connected via a GUI. For example, microservices may be displayed as logical blocks within a window, frame, other element of a GUI. A user may drag and drop microservices into an area of the GUI used to build an application. The user may connect the output of one microservice into the input of another microservice using directed arrows or any other GUI element. The application builder may run verification tests to confirm that the output and inputs are compatible (e.g., by checking the datatypes, size restrictions, etc.)

### Triggers

The techniques described above may be encapsulated into a microservice, according to one or more embodiments. In other words, a microservice may trigger a notification (into the microservices manager for optional use by other plugged in applications, herein referred to as the “target” microservice) based on the above techniques and/or may be represented as a GUI block and connected to one or more other microservices. The trigger condition may include absolute or relative thresholds for values, and/or absolute or relative thresholds for the amount or duration of data to analyze, such that the trigger to the microservices manager occurs whenever a plugged-in microservice application detects that a threshold is crossed. For example, a user may request a trigger into the microservices manager when the microservice application detects a value has crossed a triggering threshold.

In one embodiment, the trigger, when satisfied, might output data for consumption by the target microservice. In another embodiment, the trigger, when satisfied, outputs a binary value indicating the trigger has been satisfied, or outputs the name of the field or other context information for which the trigger condition was satisfied. Additionally, or alternatively, the target microservice may be connected to one or more other microservices such that an alert is input to the other microservices. Other microservices may perform responsive actions based on the above techniques, including, but not limited to, deploying additional resources, adjusting system configurations, and/or generating GUIs.

### Actions

In one or more embodiments, a plugged-in microservice application may expose actions to the microservices manager. The exposed actions may receive, as input, data or an identification of a data object or location of data, that causes data to be moved into a data cloud.

In one or more embodiments, the exposed actions may receive, as input, a request to increase or decrease existing alert thresholds. The input might identify existing in-application alert thresholds and whether to increase, decrease, or delete the threshold. Additionally, or alternatively, the input might request the microservice application to create new in-application alert thresholds. The in-application alerts may trigger alerts to the user while logged into the application, or may trigger alerts to the user using default or user-selected alert mechanisms available within the microservice application itself, rather than through other applications plugged into the microservices manager.

In one or more embodiments, the microservice application may generate and provide an output based on input that identifies, locates, or provides historical data, and defines the extent or scope of the requested output. The action, when triggered, causes the microservice application to provide, store, or display the output, for example, as a data model or as aggregate data that describes a data model.

### 11. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

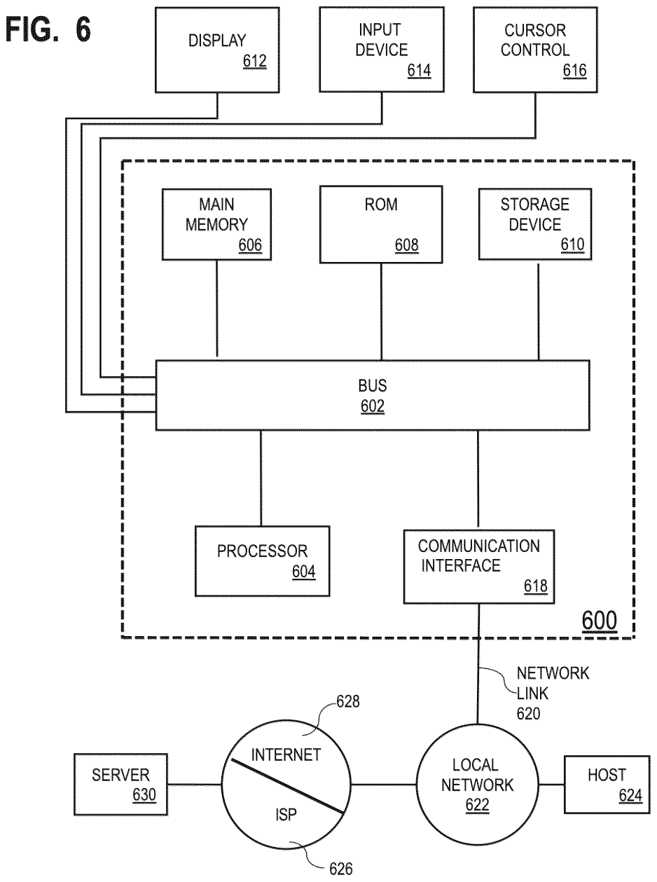

For example, FIG. 6 is a block diagram that illustrates a computer system 600 upon which an embodiment of the disclosure may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read-only memory (ROM) 608 or other static storage device coupled to bus 602 for storing static information and instructions for processor 604. A storage device 610, such as a magnetic disk, optical disk, or a Solid State Drive (SSD) is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid-state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

### 12. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. A method comprising:
generating a first region comprehension index (RCI) value that quantifies, for a first visual dataset supplied to a first computer vision model (CVM), a first bias toward global or local reasoning, at least by:
determining a first performance metric at least by applying the first CVM to a first whole image included in the first visual dataset;
determining a second performance metric at least by applying the first CVM to a first plurality of patches of the first whole image at a first granularity;
determining the first RCI value as a function of at least the first performance metric and the second performance metric;
determining if the first RCI value satisfies a criterion for deploying the first CVM to an ML pipeline; and
responsive to determining that the first RCI value satisfies the criterion for deploying the first CVM to the ML pipeline: selectively deploying the first CVM to the ML pipeline;
wherein the method is performed by at least one device including a hardware processor.

2. The method of claim 1, wherein determining if the first RCI value satisfies the criterion for deploying the first CVM to the ML pipeline comprises determining if the first RCI value satisfies a threshold value criterion.

3. The method of claim 1, further comprising:
generating a second RCI value that quantifies, for the first visual dataset supplied to a second CVM, a second bias toward global or local reasoning; and
selecting one of the first CVM or the second CVM to process a particular type of data ingested by the ML pipeline, based at least on (i) the first RCI value, (ii) the second RCI value, and (iii) a regional bias of the particular type of data.

4. The method of claim 1, further comprising:
responsive to determining that the first RCI value satisfies a threshold criterion, training a target CVM in the ML pipeline using the first visual dataset as training data.

5. The method of claim 1, wherein generating the first RCI value further comprises:
determining a third performance metric at least by applying the first CVM to a second plurality of patches of the first whole image at a second granularity;
wherein determining the first RCI value is further a function of the third performance metric.

6. The method of claim 1, wherein determining the second performance metric comprises determining a highest performance metric among a plurality of patch-specific performance metrics obtained by applying the first CVM to the first plurality of patches.

7. The method of claim 1, wherein determining the first RCI value as a function of at least the first performance metric and the second performance metric comprises:
computing a quotient of at least the second performance metric divided by at least the first performance metric; and
determining the first RCI value based at least in part on the quotient.

8. The method of claim 1, wherein determining the first RCI value as a function of at least the first performance metric and the second performance metric comprises:
determining a third performance metric at least by applying the first CVM to a second whole image included in the first visual dataset;
determining a fourth performance metric at least by applying the first CVM to a second plurality of patches of the second whole image at the first granularity;
computing a first quotient of at least the second performance metric divided by at least the first performance metric;
computing a second quotient of at least the fourth performance metric divided by at least the third performance metric;
computing an aggregated quotient based at least in part on a sum of at least the first quotient and the second quotient; and
determining the first RCI value as a function of at least the aggregated quotient.

9. The method of claim 1, wherein the first plurality of patches of the first whole image at the first granularity comprises a division of the first whole image into a first number of columns of patches and a second number of rows of patches.

10. The method of claim 1, wherein the first plurality of patches comprises non-overlapping patches of the first whole image.

11. The method of claim 1, wherein the first plurality of patches comprises patches that are equal in size.

12. The method of claim 1, further comprising:
determining a first patch-specific performance metric associated with applying the first CVM to a first patch at a first patch location in the first plurality of patches;
determining a second patch-specific performance metric associated with applying the first CVM to a second patch at the first patch location in a second plurality of patches of a second whole image at the first granularity;
generating, based at least on the first patch-specific performance metric and the second patch-specific performance metric, a graphical user interface (GUI) comprising a heatmap that visually represents relative performance of the first CVM at the first patch location and a second patch location.

13. The method of claim 1, further comprising:
generating a second plurality of patches by performing, on at least one patch of the first plurality of patches, at least one of: masking, distortion, adding noise, filtering, rotation, or shuffling;
generating a training dataset comprising the second plurality of patches;
publishing the training dataset to the ML pipeline for use in training one or more additional CVMs.

14. The method of claim 1, further comprising:
generating a second RCI associated with a second visual dataset, wherein the second RCI indicates a first regional bias of the second visual dataset;
generating a third RCI associated with a third visual dataset, wherein the third RCI indicates a second regional bias of the third dataset;
based at least in part on the second RCI and the third RCI, selecting one of the second visual dataset or the third visual dataset to train a second CVM.

15. One or more non-transitory computer readable media comprising instructions which, when executed by one or more hardware processors, cause performance of operations comprising:
generating a first region comprehension index (RCI) that quantifies, for a first visual dataset supplied to a first computer vision model (CVM), a first bias toward global or local reasoning, at least by:
determining a first performance metric at least by applying the first CVM to a first whole image included in the first visual dataset;
determining a second performance metric at least by applying the first CVM to a first plurality of patches of the first whole image at a first granularity;
determining the first RCI value as a function of at least the first performance metric and the second performance metric; and
configuring at least part of an ML pipeline based at least on the first RCI value;
determining if the first RCI value satisfies a criterion for deploying the first CVM to an ML pipeline; and
responsive to determining that the first RCI value satisfies the criterion for deploying the first CVM to the ML pipeline: selectively deploying the first CVM to the ML pipeline.

16. The computer readable media of claim 15, the operations further comprising:
generating a second RCI value that quantifies, for the first visual dataset supplied to a second CVM, a second bias toward global or local reasoning; and
selecting one of the first CVM or the second CVM to process a particular type of data ingested by the ML pipeline, based at least on (i) the first RCI value, (ii) the second RCI value, and (iii) a regional bias of the particular type of data.

17. The computer readable media of claim 15, the operations further comprising:
responsive to determining that the first RCI value satisfies a threshold criterion, training a target CVM in the ML pipeline using the first visual dataset as training data.

18. A system, comprising:
at least one device including a hardware processor;
the system being configured to perform operations comprising:
generating a first region comprehension index (RCI) that quantifies, for a first visual dataset supplied to a first computer vision model (CVM), a first bias toward global or local reasoning, at least by:
determining a first performance metric at least by applying the first CVM to a first whole image included in the first visual dataset;
determining a second performance metric at least by applying the first CVM to a first plurality of patches of the first whole image at a first granularity;
determining the first RCI value as a function of at least the first performance metric and the second performance metric;
determining if the first RCI value satisfies a criterion for deploying the first CVM to an ML pipeline; and
responsive to determining that the first RCI value satisfies the criterion for deploying the first CVM to the ML pipeline: selectively deploying the first CVM to the ML pipeline.

19. The system of claim 18, wherein determining if the first RCI value satisfies the criterion for deploying the first CVM to the ML pipeline comprises determining if the first RCI value satisfies a threshold value criterion.

20. The system of claim 18, the operations further comprising:
generating a second RCI value that quantifies, for the first visual dataset supplied to a second CVM, a second bias toward global or local reasoning; and
selecting one of the first CVM or the second CVM to process a particular type of data ingested by the ML pipeline, based at least on (i) the first RCI value, (ii) the second RCI value, and (iii) a regional bias of the particular type of data.
